(19) United States
(12) Patent Application Publication
(10) Pub. No.: US 2024/0161651 A1
(43) Pub. Date: May 16, 2024

(54) SIGN TO SPEECH DEVICE

(71) Applicant: VoiceSign LLC, Olathe, CO (US)

(72) Inventor: Angela Watson, Olathe, CO (US)

(21) Appl. No.: 18/504,270

(22) Filed: Nov. 8, 2023

Related U.S. Application Data
(60) Provisional application No. 63/383,288, filed on Nov. 11, 2022.

(51) Int. Cl. G09B 21/04; G06F 3/01; G06F 3/16; G06T 11/20

(52) U.S. Cl. CPC G09B 21/04; G06F 3/014; G06F 3/017; G06F 3/16; G06T 11/206

(57) ABSTRACT

A sign to speech device is disclosed having one or more position detection sensor(s) configured to detect physical motion of a user and generate electrical signals corresponding to the detected physical motion. A controller is configured to receive the electrical signals from the position detection sensor(s) and associate the electrical signals with a preprogrammed word, meaning, or sound. An audio output device is configured to generate audible sound for the preprogrammed word, meaning, or sound based on the electrical signals corresponding to the detected physical motion. Program code stored on computer readable media is executable by a computer processor to define a new physical gesture of the user.

### PRIORITY CLAIM

This application claims the priority filing benefit of U.S. Provisional Patent Application No. 63/383,288 filed Nov. 11, 2022 for “Sign To Speech Device” of Angie Watson, hereby incorporated by reference in its entirety as though fully set forth herein.

### BACKGROUND

Millions of people around the world can hear, yet not talk. These people are often referred to as “nonverbal.” It is important to understand what that means. Some people use the word “mute” to describe people who are deaf. In addition to being an outdated term, it is also offensive, inappropriate, and incorrect. Mute means silent—refraining from speech or utterance, or rather not emitting or having sound of any kind. Thus, it is a misnomer to label people who are deaf as mute. Deafness affects the ears, not the vocal cords. The reason some deaf people do not talk is because learning how to articulate sounds with the mouth develops when the person hears example sounds from external sources and then hears how their voice sounds when trying to replicate it. Talking develops as a person fine-tunes their vocalizations to mimic external sounds. What this means is deaf people are not mute. They emit many kinds of sounds; they simply cannot hear how to develop their sounds. Some overcome this with years of training with specialized, hearing, speech-language pathologists. Others use cochlear implants or hearing aids to observe their voice.

Another group of people who have historically been inappropriately labeled as mute, and are the primary population the sign to speech device serves, are people who can hear yet not talk. The appropriate terminology for this group is “hearing-nonverbal,” or simply “nonverbal,” and is often associated with genetic syndromes, physical diseases, and/or developmental delays.

Even though there are exponentially more people who are nonverbal than deaf, the nonverbal are an overlooked population when it comes to sign language. For example, out of the 7,300,000 students enrolled in US public schools during the 2019 to 2020 school year, there were 7,300 to 18,250 children who were deaf and 821,250 to 1,642,500 or more who were nonverbal, however it is only the Deaf who are provided with sign language interpreters. Even dictionaries overlook the Nonverbal when defining sign language as a communication system for people who cannot hear.

Unfortunately, there is not a specific category identifying people who are nonverbal. Instead, they are grouped within other disability categories. Based on definitions of the disabilities which qualify for special education, people who are nonverbal can be categorized as having speech or language impairments, autism, developmental delays, intellectual disabilities, or multiple disabilities. Combining these categories totals 45% of the total population served with specialized education, or 3,285,000 students. Not all of these students are nonverbal though, and studies lack an exact number for reference. Research indicates 25% to 50% of people with autism are nonverbal, while 1 in 4 people with cerebral palsy cannot talk. People experienced with special-needs classrooms across the nation, find up to one-half of the students, if not more, are nonverbal. Thus, an average of 25% to 50% was applied across the IEP categories non-verbalism can fall under, which yielded approximately 821,250 to 1,642,500 nonverbal students. Although the policy manual for special education eligibility criteria lists Deafness as its own category, it is also often lumped into Hearing Impairment. Gallaudet University has found when such happens, the number of people who are actually deaf is approximately 4 to 10 times less than the category's total, which yielded the 7,300 to 18,250 range for deaf students.

The hearing nonverbal are long overdue for a way to respond to others in the language which they are spoken to, using the words they hear, and formulating with words the complete thoughts their minds produce. The nonverbal deserve to be heard with a communication system which can easily and appropriately serve them from preschool through college and beyond.

### BRIEF DESCRIPTION OF THE DRAWINGS

FIG. 1 shows example components of a sign to speech device.

FIG. 2 shows an example primary wristband with a printed circuit board, and an inertial measurement device.

FIG. 3 is a skeletal illustration of a hand showing example placement of flex sensors of the sign to speech device.

FIG. 4 shows example circuitry for the sign to speech device.

FIG. 5 shows the example circuitry of FIG. 4 as it may be worn on a user on his or her hand.

FIG. 6 is a high-level block diagram of example operational units of the sign to speech device.

FIGS. 7A and 7B illustrate example gesture mapping operations of the sign to speech device.

FIG. 8 is a high-level block diagram of example mapping inputs of the sign to speech device.

FIG. 9 illustrates example operation of a wristband of the sign to speech device.

FIGS. 10A-B, 11A-B, and 12A-B illustrate an example user interface and corresponding processing by a computing device of the sign to speech device.

FIG. 13 is a high-level block diagram of an example computing environment in which the sign to speech device may be implemented.

FIG. 14 shows an example architecture of machine readable instructions, which may be executed by the sign to speech device.

FIG. 15 is a flowchart diagram illustrating example operations implemented by the sign to speech device.

### DETAILED DESCRIPTION

The sign to speech device described herein is the solution for nonverbal people, their gateway to live, and literally their voice. The sign to speech device gives people a voice they can use throughout their everyday life, and one which approaches natural communication.

An example sign to speech device may be implemented with specialized hardware (e.g., structural and electronic components) and software or program code stored on a computer readable media and executable by a computer processor or processing device. As described throughout, the combined attributes of the device make the system uniquely suitable for the widest range of demographics possible. Yet, with regard to the Nonverbal, the most important features are perhaps the full customization options of the unencumbered textiles, the self-containment of the system, and the input detection algorithms.

The sign to speech device gives people who are nonverbal the ability to communicate in a manner approaching natural communication. People who are nonverbal include people with syndromes such as Downs Syndrome and autism, and diseases like multiple sclerosis and strokes. Since an overwhelming majority of people who are nonverbal also have unique and special physical and/or mental needs, careful planning by people who live nonverbal lives has been incorporated to ensure the sign to speech device properly suits the demographic.

To accommodate a variety of people, users may utilize different combinations of bands (components of the sign to speech device). Two examples are if a stroke victim has lost the use of one of their arms, they may only use bands on their working arm, or if someone with special needs has sensory challenges with their hands, they can use less finger bands or none at all. Additionally, each band is cut to the user's exact measurements, so the fit is always perfect and can accommodate any size. Other features created with special needs in mind are the music and visual components of the system, which encourages users to wear, practice, and speak with the device, and the training program which presents itself as video games users control with their arms.

The speech component of the system is designed to accommodate the sign system (a sign system created to represent spoken languages and is for people who can hear), but it is not limited to conventional sign systems. Instead, the sign to speech device can be highly customized for each individual user, based on their own abilities, desires, and people with whom they are interacting.

It should also be noted that the sign to speech device may also include other output options, including but not limited to music and streaming. As such, the sign to speech device is not only intended to be used by people who are nonverbal. Other people who may also naturally benefit from the device include, by way of non limiting example, musicians, singers, visual artists, dancers, storytellers, and hobbyists. Anyone who wants to include gestural and motion control in their routine may benefit from the sign to speech device disclosed herein.

There is no other known device which allows the customization of components; one simply uses the device as it is offered. With the device disclosed herein, and apart from needing one wristband, users can select which additional components fit their personal needs. This may be important for people who are hearing-nonverbal since their physical abilities can differ drastically from one person to another.

Before continuing, it is noted that as used herein, the terms “includes” and “including” mean, but is not limited to, “includes” or “including” and “includes at least” or “including at least.” The term “based on” means “based on” and “based at least in part on.”

In addition, the term “nonverbal” as used herein means people who can hear, yet not talk.

The term “deaf” as used herein means people who cannot hear.

The term “approaching natural communication” as used herein means the ability to spontaneously communicate throughout each day, while simultaneously participating in activities of any kind and in a manner which allows the speaker to turn their body to make eye contact, increase and decrease their volume, and interrupt and be interrupted.

The term “arm” as used herein means the portion of the human body extending through the hand and includes the shoulder, upper arm, forearm, wrist, palm, and fingers.

The term “band” as used herein means a thin, flat strip of any suitable material for binding, confining, trimming, protecting, etc. The term “material” is not limited to cloth, and can include other textiles, synthetics, plastics, etc.

The term “PCB” as used herein means an acronym for Printed Circuit Board.

The term “IMU” as used herein means an acronym for Inertial Measurement Unit. IMUs send pitch, yaw, roll, and acceleration to the PCB.

The term “COM Kit” as used herein means a user-defined combination of bands.

The term “input” as used herein means representative input (e.g., electrical signals from sensors or other devices) to be assigned to maps and associated with outputs. Example input includes, but is not limited to, handshapes, locations, wrist rotations, palm tilts, movement, and button and switch positions. Input may include a range of defined coordinates.

The term “input mapping” as used herein means a combination of inputs which, when all criteria are met, produce a user-defined output.

The term “handshape” as used herein means collective ranges of one or more flex sensors in activated bands, excepting the palm tilt flex sensor on the wrist.

The term “location” as used herein means collective pitch, yaw, and roll coordinates or ranges of coordinates from the IMU(s) defining different spaces around the body.

The term “wrist rotation” as used herein means segmented roll ranges from the wrist IMU determining the rotational angle of the wrist and palm.

The term “palm tilt” as used herein means flexion of the palm. Coordinates come from the flex sensor positioned on top of the wrist where the ulna and radius bones meet.

The term “padding” as used herein means automatically setting handshapes to determine how large of a range is captured.

The term “MIDI” as used herein means an acronym for Musical Instrument Digital Interface and is a technical standard describing a communications protocol connecting a wide variety of electronic musical instruments, computers, and related audio devices for playing, editing, and recording music. Other protocols now known or later developed may also be included within the definition.

The term “OSC” as used herein means an acronym for Open Sound Control which is a protocol for networking sound synthesizers, computers, and other multimedia devices for purposes such as musical performance or show control. Other protocols now known or later developed may also be included within the definition.

The term “output” as used herein means a type of output to be associated with input mappings and is triggered when associated input criteria are met. Example output includes but is not limited to audio output such as speech, piano, playlist, external, and volume. Other types of output may also include visual, tactile, and other types of output. Output may represent the action within an output terminal which is triggered when the associated input criteria are met. By way of example, output may be a specific note and its duration when using a music terminal.

The term “output mapping” as used herein means a defined output or set of outputs associated with an input mapping.

The term “map” as used herein refers to both an input mapping and the output(s) it triggers.

The term “cluster” as used herein means a set of maps to be used independently, or rather without interference, of other maps.

The term “sign system” as used herein means any sign system which gesturally replicates spoken language(s) (conventional or custom created) to be recognized by the sign to speech device and/or associated program code.

It is also noted that the examples described herein are provided for purposes of illustration, and are not intended to be limiting. Other devices and/or device configurations may be utilized to carry out the operations described herein. Likewise, the operations shown and described herein are provided to illustrate example implementations. It is noted that the operations are not limited to the ordering shown. Still other operations may also be implemented.

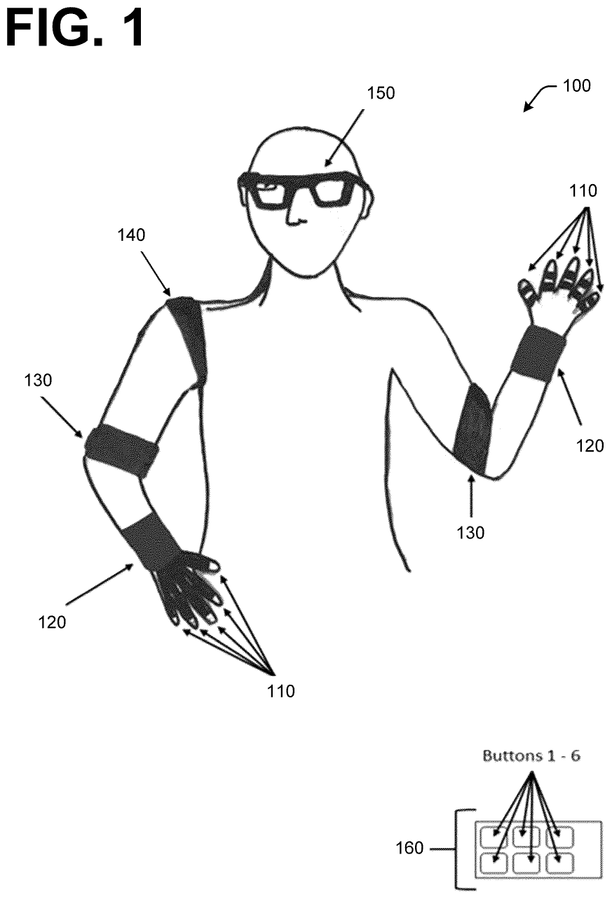

FIG. 1 shows example components of a sign to speech device 100. The example sign to speech device 100 may include one or more band, such as one or more finger band(s) 110, one or more wrist band(s) 120, one or more elbow band(s) 130, and one or more shoulder band(s) 140. The example sign to speech device 100 may also include a feedback viewer 150, and a hand-held device or “button board” 160.

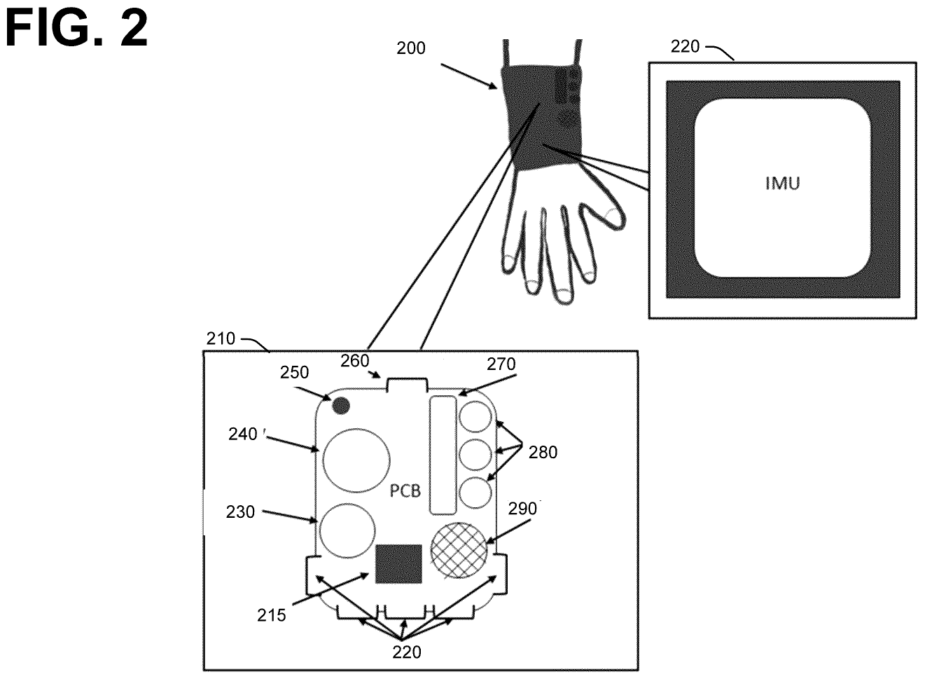

FIG. 2 shows an example primary wristband 200 with a printed circuit board (PCB) 210, and an inertial measurement device or sensor 220. The PCB 210 may include a processor or processing device (e.g., a microchip) 215 and associated computer-readable storage or memory. The PCB 210 may include one or more finger band connector 220 for connecting to sensors in the finger bands (see, e.g., FIG. 1). The PCB 210 may also include a haptic motor 230, battery 240, on/off switch or button 250, a USB or other data connector 260, an input button 270, LED lights or other visual output device 280, and a speaker or other audio output device 290.

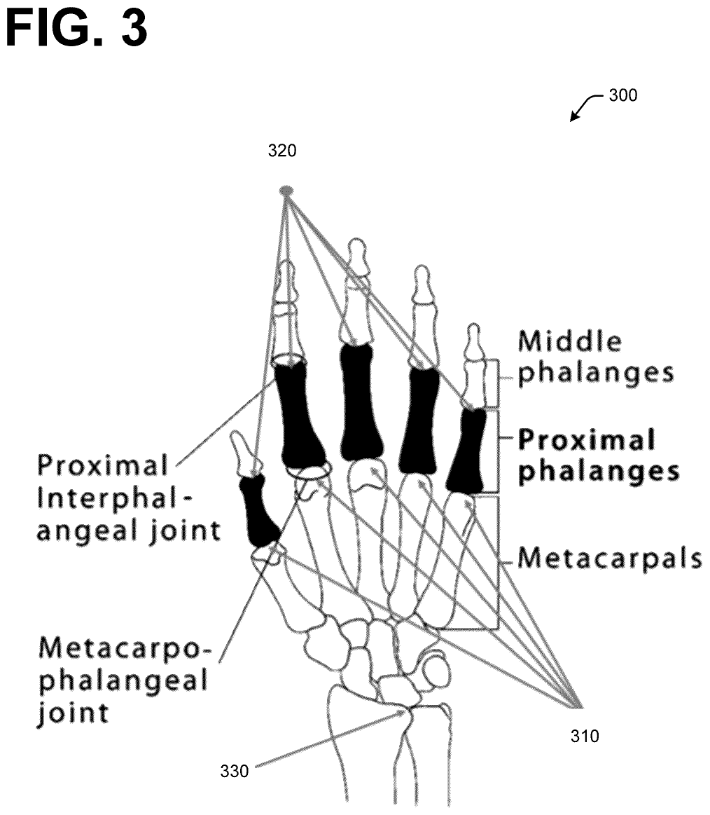

FIG. 3 is a skeletal illustration of a hand 300 showing example placement of proximal flex sensors 310, a distal flex sensor 320, and a palm flex sensor 330 of the sign to speech device. It is noted that any number and/or type of these sensors may be positioned in any one of these or other locations.

An example of the device has seventeen bands of fabric wrapped around key points of the arms—each finger, palm knuckles, wrist, elbow, and one shoulder. Within the bands are IMUs to track pitch, yaw, orientation, and acceleration, flex sensors to measure the bend of joints, and a PCB to retrieve and send communication signals. Additionally, the unit includes LED lights and haptic motors for feedback, and a built-in speaker for output. All users don a primary wristband, after which they may use any combination of the remaining bands to suit their personal needs. A hand-held button board for users and/or their assistants is included for system control and defining inputs. The device connects to the computer or computing device wirelessly or with a USB cable. Setup and mappings are performed on a computer. When definitions are written to the primary PCB, the device can be used independently of a computer, internet, and mobile device, at which point smart glasses can be used for viewing feedback. The bands are worn under clothing. In addition to speech the system may also provide music outputs, instructional guides, modifiable speech and music presets, user-created mappings, and training games.

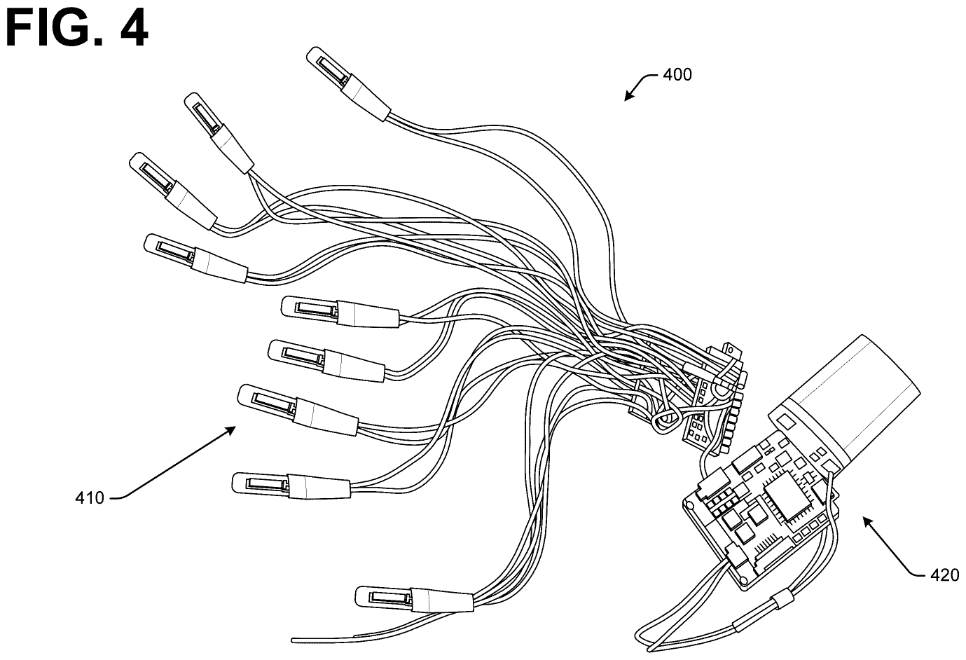

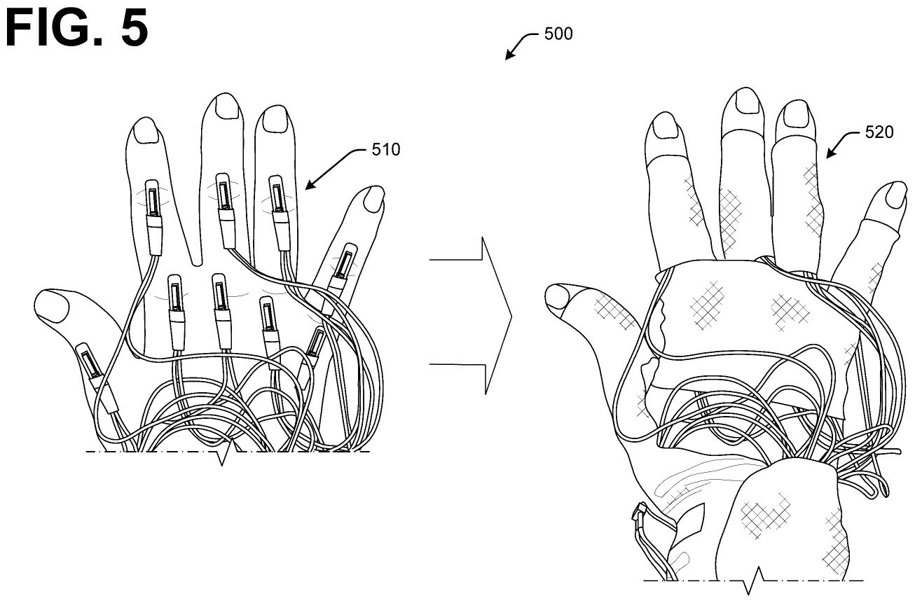

FIG. 4 shows example circuitry 400, sensors 410, and the PCB 420 of the sign to speech device. FIG. 5 shows the example circuitry 500 and sensors 510 of the sign to speech device, as it may be worn on a user on his or her hand. In an example, the device is durable, wearable, waterproof, self-contained, and translates the sign system into speech.

In an example, the device includes custom-fit bands made of lightweight, breathable, fray-less, stretchable, non-toxic water repellent fabric which wrap around various points on the arm. For example, ten bands may be provided for each finger on each hand. Two more bands may wrap around the palms of each hand, while another four bands wrap around the wrists and elbows. Another band rests on one of the shoulders. Users may choose to wear one wristband, all of the bands, or any combination thereof. In an example, a set of particular bands is called a Com Kit.

Some bands may have pockets, which hold one or more pieces of hardware. As bands are added to the Com Kit, the motion and gestural control algorithms become more defined. That is, the number of bands directly relates to an increase in the number of possible inputs and thus, outputs, or rather device/user potentiality. Defining the inputs and outputs, and creating mappings occurs on a computer. Then definitions are written to the primary PCB, at which point the device can be used independently of a computer.

In an example, two wristbands are provided. One wristband is the primary band. It can be used independently of all other bands. However, to use any other band, the primary wristband should be on and activated. The primary wristband receives real-time coordinates from all other bands, produces associated outputs and includes the motherboard.

Aside from the above differences, the secondary wristband may include the same functionality as the primary wristband. These each include an IMU and a PCB with LED lights, an input button, an on/off button, a haptic motor, connectors, and other various pieces of hardware.

In an example, the textile is a band of fabric (or other suitable material) placed on the wrist of one or both arms. Within each band is a pocket holding a PCB, IMU, and battery. The pockets are accessible to the user so the hardware can be charged and/or removed when necessary. The width of the wristband is approximately 9 cm, while the length equals the circumference of the user's wrist. The lengthwise edges are sewn together so the finished band slips on over the user's hand.

In an example, each wristband includes an IMU. Coordinates from the wrist IMU are transmitted to the computer and PCB allowing real-time 3D orientation as well as calibrated 3D acceleration, angular velocity, and (earth) magnetic field.

In an example, each wristband includes a PCB with components such as a BLUETOOTH™ transmitter, a computer chip, a haptic motor, LED lights, a battery, an on/off button, an input button, and a USB connector, among other necessary hardware, such as resistors, transistors, capacitors, inductors, diodes, switches, and cooling and emergency shut-off mechanisms. The PCB on the primary wristband differs from the secondary PCB in that the primary PCB includes functionality to receive wireless communications, execute the program code described herein, and send outputs to a speaker. Both PCBs have USB connectors for charging and are enclosed in a durable, waterproof housing.

In an example, a button to power on and off each PCB is located on the proximal side of the circuit board. Each PCB includes a USB female connector in the center of the proximal side of the PCB. A USB cable is inserted into the USB connector for charging and transfer purposes. Each PCB includes a button which sends button press signals to the processor and is available as an input option for mapping. Each PCB hosts LED lights to receive customized output signals from the processor. Users have the ability to control blink time, pattern, lumosity, and color. The PCB on the primary wristband may include a speaker for built-in sound output.

In an example, the chip on the secondary PCB sends real-time finger bend and button signals to the chip on the primary PCB. The chip on the primary PCB receives the real-time signals from the secondary PCB, along with all activated IMUs and the primary-hand's finger bands, and either routes said input to a wirelessly connected computer or executes the program code on the chip itself and sends sound outputs to a speaker.

In an example, a haptic motor may be included on each PCB to receive output signals from the program code, including vibration pattern, strength, and speed. Each IMU receives power from a small, rechargeable battery. The PCBs tie into the IMUs' power. Also included on the PCB is a wireless receiver and transmitter such as communications modules, resistors, transistors, capacitors, inductors, diodes, switches, a cooling and emergency shut-off mechanism, etc.

In an example, a band of fabric is placed just above one or both elbows at the lower bicep and is holding a sensor in place to measure the bend of the elbow. The elbow sensors are easily accessible. The width of the band is about two inches, and the length approximately equals the circumference of the arm at the band placement area.

In an example, the device has one shoulder band, which is made from a strip of fabric wrapping around the user's shoulder and armpit. The band can be worn on either shoulder. Within the band is a pocket holding an IMU, which is placed on the acromion part of the shoulder. Like with the other IMUs, the shoulder IMU wirelessly transmits 3D orientation, acceleration, angular velocity, and (earth) magnetic field input. The system specifically utilizes the yaw orientation coordinates as the parent yaw coordinates, so all other IMUs can be addressed relative to the shoulder IMU. In other words, utilizing a shoulder IMU allows the user to move around while keeping their locations relative to their body. Without the shoulder band, the locations are relative to magnetic north and when users move, their locations do not move with them. The IMU is easily accessible for charging needs. The width of the shoulder band is about 3 cm. The length of the shoulder band equals the circumference of the user's arm at the arm pit.

In an example, finger bands may include short flex sensors secured over the proximal interphalangeal joints of the fingers and thumbs, and then covered with a band of fabric. The length of the band equals the length from just below the user's distal interphalangeal joint to the fingers' base, excepting the thumb bands which extend and connect to the wristbands. The finger band circumference equals the width of the user's middle phalanges. An additional sensor is placed on the palm knuckle of each thumb and shares the same band as its proximal joint.

In an example, flex sensors are secured over the palm knuckles of each hand, then covered with a band of fabric. The length of the band is about 4.5 to 5 cm and the circumference equals the circumference of the user's palm at the knuckles.

An optional set of input buttons may be included on a hand-held, wireless board. Additionally, the board includes one on/off button, a battery, a USB connector, and a wireless transmitter. When pressed, each button sends a message, which can be implemented with input mappings, or for the main intent, which is to remotely control setup and menu functions, and is most especially helpful for assistants. A use example is when the hand-held button board is controlled by an individual other than the user, such as a speech therapist who is setting up the device for their clients. Another application for the button board may be for users who do not have finger bands and want extra input controls during a performance.

Another optional component is a feedback viewer, which may be activated when using the device away from a computer. In an example, the feedback viewer is a pair of smart glasses which receive real-time input and project the output for the user to view. Increases in user-defined inputs (e.g., handshapes, locations, etc.) mean more potential outputs. It also means that the user has to be more exact with constructing the appropriate gestures and motions at the defined points in space to produce correct outputs. Being able to see what is registering quickly becomes necessary for success. For users who are deaf, having a feedback viewer is essential since they cannot hear the outputs from sign-to-speech devices. The following sections includes a summary of example features of the sign to speech device.

In an example, the device textiles are bands and there is minimal fabric placed on the hand. As such, hand temperatures remain consistent with the ambient air, fine motor skills are allowed to advance, and sensory impact is greatly lessened. Because bands are used instead of gloves, the fit is more accurate and the finger sensors stay properly positioned. The device textiles are lightweight, breathable, and barely feel like an electronic textile is donned.

In an example, the sign to speech device can be packaged as a kit for user assembly, which ensures an exact fit, and allows users to understand their device better, while saving money. Easy to follow instructions, along with live support is provided to users and their assistants. The sign to speech device can also be packaged pre-assembled.

Not all the bands have to be donned for the sign to speech device to work, allowing for optimum user customization, which is important because many people who are nonverbal have unique ranges of movement and abilities. The device may at least have one primary wristband, after which users may add the secondary wristband, one or both of the elbow bands, the shoulder band, and/or any of the finger bands. An example of customization is when a user has Dupuytren's Contracture—a condition which permanently bends fingers into a fixed location—and their ring and little fingers are affected, so they leave these fingers out of the finger band setup, using only the index, middle, and thumb.

Non-verbalism is commonly accompanied with Tactile Defensiveness (TD), which refers to the brain's inability to process and use information through the senses, and is a pattern of observable behavioral and emotional responses, which are aversive, negative, and out of proportion, to certain types of tactile stimuli in which most people would find to be non-painful. Because the sign to speech device textiles include minimal fabric and stitching, and are made from thin, light, stretchable, and breathable material, the device produces extraordinarily little sensory impact. Additionally, as mentioned above, the device can be used without certain bands to lessen the impact even more.

If any part of the textile needs replacing, users have several options. Since the sign to speech device is packaged as a kit and accompanied with instructions and patterns, users are empowered to purchase a swatch of material at their local fabric store and replace the part themselves, which means in a matter of hours they can have their “voice” fully repaired. The other options are to purchase replacement parts or send their textiles in for manufacturer repair.

In an example, the sign to speech device is that it can be made to fit any sized hand, specifically children's and people with uniquely shaped hands.

The sign to speech device is durable and can take a beating. The IMUs and circuit boards are stably set within protective, waterproof housings (see below) and can withstand impacts.

The sign to speech device is waterproof. The IMUs are waterproof, the PCBs are placed inside a waterproof housing, the flex sensors are naturally waterproof, and the wires connecting the sensors to the PCB are appropriately sealed. The device can withstand being held under running water or can even be completely immersed for a short time. The ingress protection rating for the device is IP67 where 6 indicates complete dust protection (no ingress of dust) and 7 means the device is protected against temporary submersion in water up to one meter for thirty minutes.

The sign to speech device is self-contained, meaning “all that is necessary in itself.” Users may write their definitions to their primary wristband and then walk away from the computer. There is no need for a Wi-Fi connection or an external application to use the device.

In an example, the device is customizable. The primary wristband may be used independently or with any combination of other bands. The primary wristband provides wrist orientation and acceleration, while hosting the motherboard. At any time, users can incorporate additional bands to increase available inputs/user potentiality.

In an example, the sign to speech device utilizes an IMU on the shoulder, enabling users to freely move around their environment and still communicate.

In an example, users have the added orientation of the elbows with a sensor in or under each elbow band, which play an important role in sign language. Without tracking elbow orientation, the user will have difficulty differentiating multiple depths—spheres of closeness to the body. For example, given the same wrist orientation, placing the wrist out in front of the body yields the same coordinates as placing the wrist close to the body on the same transverse plane. Using a sensor on the elbow allows for easy differentiation of these two positions, and exponentially more.

In an example, a haptic motor is included on each wristband's circuit board and can be mapped as outputs for feedback. Users can customize the speed, intensity, and pattern of the vibrational feedback. Some use examples are a long, soft buzz produced when the user's arm moves into certain locations, a short, soft buzz followed by a short hard buzz indicates a particular elbow orientation, and a short, medium buzz confirms menu navigation options.

In an example, LED lights may be sewn into the wristbands to provide users with visual feedback. A common use of the device LED lights is to show which handshape the device is registering, which helps users and their assistants know if they need to adjust their finger positioning or not. The device comes with over 30 preset handshapes, all of which are associated with a specific color and can be modified to suit each user's unique dexterity. A use example is when the “g-hand” is associated with green, the “r-hand” with red, and the “c-hand” with a carnation pink color. With three lights on each wrist, users have an exponential number of possible feedback combinations as color, blink time, intensity, and pattern can be customized for each light.

In an example, the device includes an optional hand-held, remote control board to assist users and their assistants with the menu navigation and setup procedures. Users can also utilize the buttons on the board as inputs in mappings.

The sign to speech device disclosed herein may be made of a light-weight material of custom-fit textiles. Indeed, the textiles can readily be made by the user at home because the device utilizes bands instead of gloves. By nature of design, gloves are difficult to make, bulky, uncomfortable to wear all day, and hands become hot and sweaty. There are a lot of seams, which can leave markings on the hands and inhibit the range of movement in the fingers. Gloves come in limited sizes and may not be available in children's sizes, which means these do not fit everyone the same, if they even fit at all. Some gloves can be a bit loose, while others are too tight, which affects the readings of the hardware devices in negative ways. Custom made gloves, if possible to make, can be much more than their standard price, and take well over one year to make, and still may not fit properly. It is noted, however, that the device as described herein does not exclude the use of gloves.

The textile is simple, yet works amazingly well. The textiles are light weight with minimal seams. These are comfortable to wear all day, and do not inhibit range of motion. In fact, it is easy to forget you have them on. The bands allow for airflow, so the hands stay comfortable. The pattern is easy to custom-fit to each person's unique hand shape, which not only furthers the comfort and the accuracy of the hardware, it also allows users to make their own bands. Any textile will wear out over time. Can you imagine someone using the device every day to communicate and then one day they get a tear in the fabric and have to send their device off for repair? It means the user suddenly has to go without their voice for a number of weeks at the minimum. With the textile implementation disclosed herein, the user or their assistant can quickly make a new band to replace the torn one.

The bands also allow ease of customizable device components. When the user has a set pattern for a glove, it is challenging to leave out some of the fingers. This is not the case when you have individual bands for each finger.

The device can also be used independently (e.g., without a dedicated computer or phone/tablet). Although the setup is performed using a computer (or mobile phone, etc.), it is then written to the primary wrist device that the user can walk around with and sign while producing instant outputs.

An example elbow band may be assembled as follows. These steps are merely illustrative examples and are not intended to be limiting in any manner. 1. Measure the circumference of the arm at the lower bicep and note it as EC for elbow circumference. This is the length of the elbow band. 2. Cut one strip of fabric about 10 cm (e.g., the width doubled)×EC. Find the middle of the length and mark it. 3. Draw a chalk line widthwise about 1.5 cm from one side of the middle, then repeat on the other side. 4. Sew about 0.5×1.5 cm hook-and-loop strip along the edge of the middle, in between the chalk lines. 5. Fold the fabric in half lengthwise so the hook-and-loop fasteners lay on top of each other with the backsides touching. 6. Starting at the chalk-line next to the hook-and-loop, stitch along the lengthwise edge, sewing away from the middle. Repeat from the other chalk-line. 7. Turn the band inside-out. 8. Find the middle again and redraw the chalk-lines as described in Step 3. 9. Stitch along each chalk-line from side to side. 10. Place the sensor inside the pocket and fasten the hook-and-loop. 11. Slip the elbow band onto the arm so the IMU rests on the outside of the lower bicep.

An example shoulder band may be assembled as follows. These steps are merely illustrative examples and are not intended to be limiting in any manner. 1. Measure the circumference of the arm at the armpit and note it as SC for shoulder circumference. This is the length of the shoulder band. 2. Cut one strip of fabric about 10 cm (the width doubled)×SC. Find the middle of the length and mark it. 3. Draw a chalk line widthwise about 1.5 cm from one side of the middle, then repeat on the other side. 4. Sew about a 0.5×1.5 cm hook-and-loop strip along the edge of the middle, in between the chalk lines. 5. Fold the fabric in half lengthwise so the hook-and-loop fasteners lay on top of each other with the backsides touching. 6. Starting at the chalk-line next to the hook-and-loop, stitch along the lengthwise edge, sewing away from the middle. Repeat from the other chalk-line. 7. Turn the band inside-out. 8. Find the middle again and redraw the chalk-lines as described in Step 3. 9. Stitch along each chalk-line from side to side. 10. Place the IMU inside the pocket and fasten the hook-and-loop. 11. Slip the shoulder band onto the arm so the IMU rests on top of the shoulder. 12. Place a small piece of double-sided body tape on the acromion to hold the band in place.

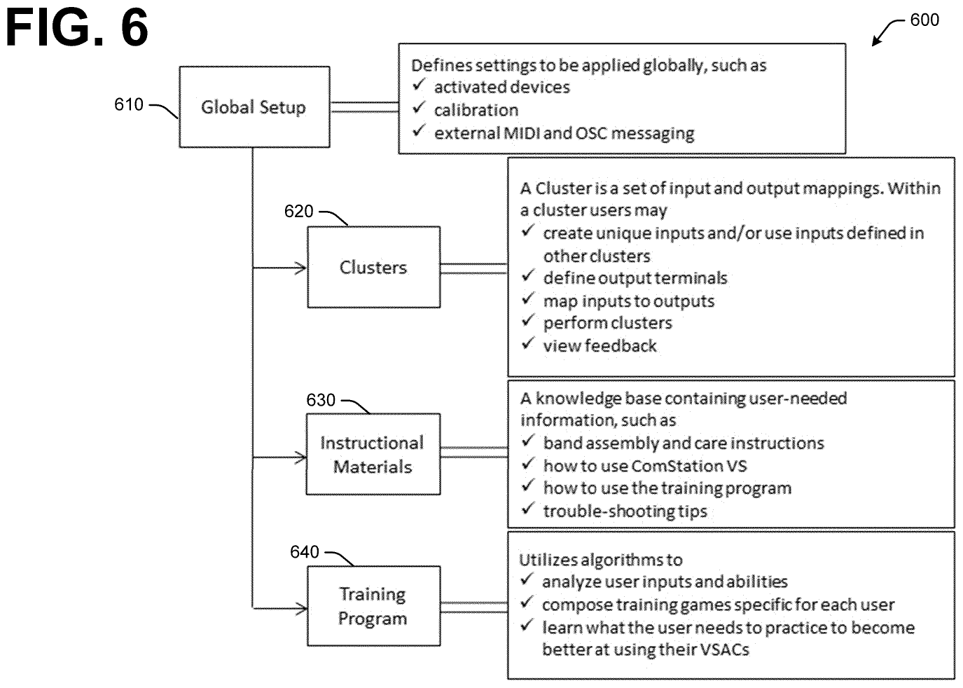

FIG. 6 is a high-level block diagram of example operational units 600 of the sign to speech device. The device is designed to trigger speech outputs, while allowing users to customize the sound, speed, and pitch of the produced voice.

In an example, operational units 600 may include a global setup operational unit 610. The global setup operational unit 610 defines settings to be applied globally. Examples include, but are not limited to, activated devices, calibration, and external MIDI and OSC messaging.

Example operational units 600 may also include a clusters operational unit 620. The clusters setup operational unit 620 generates clusters. A cluster is a set of input and output mappings. Within a cluster, users may create unique inputs and/or use inputs defined in other clusters. Users may also define output terminals. Users may also map inputs to outputs. Users may also perform clusters and view feedback.

The example device includes built-in speech presets for each possible Com Kit. Meaning, users can turn on their device(s), calibrate, and speak right away. To learn how each sign triggers the corresponding speech output, users have the option of clicking on the input mapping and previewing a demonstration of the sign, or the user may refer to the built-in, automatically generated input mapping demonstration for the entire cluster (e.g., the instructional material and/or “build your own speech” program). Users can copy individual speech preset mappings or an entire cluster and modify the mappings and/or add additional ones.

In an example, along with customizing speech presets, users may build their own speech maps according to their own unique signing style and preferences. As speech terminals are declared, the system automatically stores the word or statement in a real-time sign dictionary where information is displayed regarding the word/statement such as which clusters they are used in and an animated preview of the mapping.

In an example, the device enables users to have their “voice” naturally with them and on them throughout most of their day, every day. They can turn their torso to make eye contact, move independently of a computer, phone, and internet, and thus, participate in day-to-day activities while also being able to speak. Users also experience an important nuance of conversation, which is the ability to interrupt, be interrupted, and turn their volume up. All of these approach natural communication.

Example operational units 600 may include an instructional materials operational unit 630. The instructional materials operational unit 630 includes a knowledge base of user information. Example user information may include, but is not limited to, band assembly and care instructions, how to use the device, how to use the training program, and troubleshooting tips.

Example operational units 600 may include a training program operational unit 640. The training program operational unit 640 may include algorithms to analyze user inputs and abilities. The training program operational unit 640 may also include algorithms to compose training games customized to individual users. The training program operational unit 640 may also include algorithms to determine what the user needs to practice to become better at using their own device.

In an example, instructional materials provide a knowledge base of information relating to the sign to speech device. Bookmarks, completion indicators, progress bars, notes sections, and easy-to-use navigation links are some of the functionalities included within this section. All instructions presented to the user are based on the selected Com Kit. For example, if Com Kit X includes a wrist and shoulder band, instructions presented will be related to wrist and shoulder bands, and information regarding the elbow and finger bands will not be included. Topics of instruction include, yet are not limited to how to setup clusters, how to create inputs, how to use output terminals, understanding the feedback panel, how to navigate the training program, how to let the machine train you, how to connect to the Feedback Viewer, tips on using the device, how to sign the sign system, how to sign the input mappings in selected clusters, and how to clean the bands. Quick links to specific instructional topics are placed at corresponding areas throughout the training program and clusters.

In an example, customized training is provided for the user and is presented in the form of one or more games, where users are challenged to mimic system produced inputs based on activated devices. As users successfully reproduce the inputs, the system increases the difficulty of the challenges. When users do not reproduce the inputs, the system decreases the difficulty of the challenge while also analyzing which types of inputs users are struggling with so as to provide future games homing in on overcoming said struggle.

Users have the option of beginning their training sessions from scratch, using an existing cluster as a reference for their training, or beginning their training where they last left off. When users select to begin their training from scratch, the system presents a rudimentary challenge and increases difficulty with user success. When users select to use an existing cluster as a reference for their training, the system identifies each input mapped in said cluster and produces them in the challenges. When users are successful at meeting their challenges, the system increases the difficulty by producing more inputs similar to those previously identified. When users do not meet their challenges, the system identifies which inputs they struggle with most and adjusts the challenges until successful reproduction of the inputs are achieved. As users become successful, the system readjusts the challenge inputs in a manner bringing their ranges closer to the cluster ranges. This “ebb and flow” of the algorithm allows users to experience success while continuously being challenged, along with identifying exactly what users need to practice in order to increase the successful execution of increasingly complex mappings. When users end training sessions, the system stores the training data, so users can pick up where they left off at a later time.

An example of a training game is a maze where users follow paths on the screen to improve their orientation skills where the system presents a path and an indicator of where the user's wrist(s) is(are) based on real-time input. The wider the path, the easier it is for users to follow. When users are moving along the path properly, the system plays music and displays visuals. After users are repeatedly successful at staying on the path, the system narrows the path and creates more curves and turns. When users stray off the path, the music and visuals stop. After the user strays too many times in a row, the system widens the path and reduces the curves and turns. Additional inputs increase the complexity of the challenge, such as handshapes, wrist rotations, and palm tilts.

In an example, music can also be provided with the sign to speech device. According to Harvard University music listeners score higher in areas of mental well-being, reduced anxiety, and less depression. Music improves brain health and the ability to learn new things, while actively engaging in music increases happiness and cognitive function. Additionally, many people who are nonverbal experience limitations engaging in music. With the device, users can easily switch from talking to producing melodies with instruments they might never be able to play otherwise, such as guitars, pianos, violins, flutes, drums, or even didgeridoos.

In an example, the device may include its own group of musical templates that the user can use and/or customize to suit their particular needs. The templates provided may vary depending on which arm bands are activated. Even if a user only has a wristband, they will be able to play a variety of music on a variety of sounds right out of the box.

In an example, users may create their own music using the built-in sounds. Input options are based on activated arm bands. User-adjustable parameters include tempo, pitch, reverb, chords, notes, and more.

In addition to speech and music, the device may also include a streaming terminal where real-time input can be routed to an external program through OSC and/or MIDI messages.

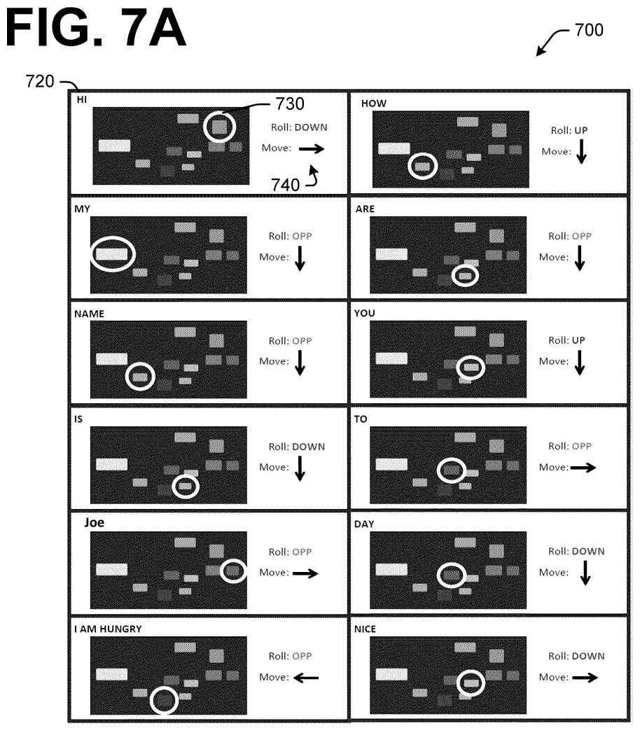

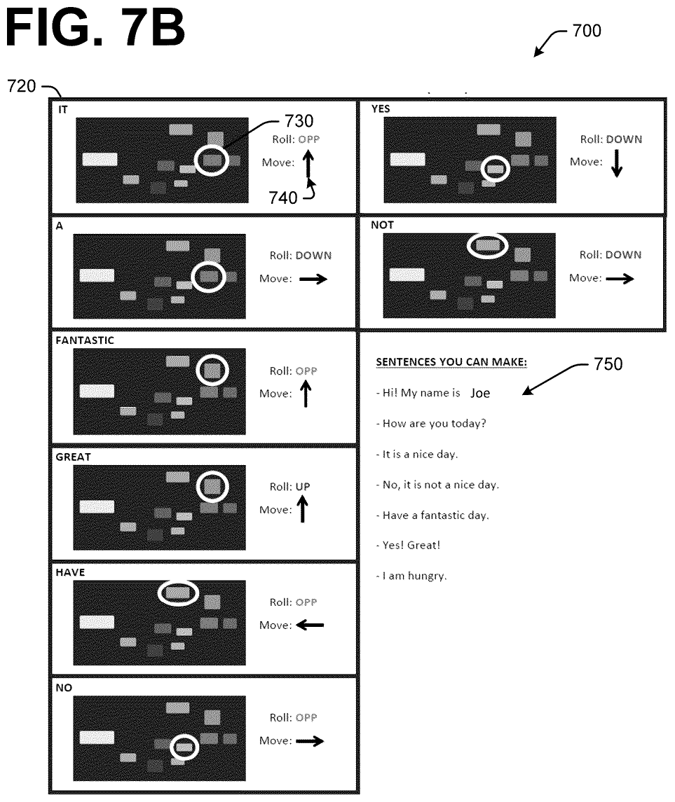

FIGS. 7A and 7B illustrate example gesture mapping operations 700 of the sign to speech device. These diagrams illustrate example active maps 710. Active maps 710 are positional representations corresponding to the user's gestures. In an example setup mode, the user can define words or other audio output corresponding to specific gesture(s) and store these as maps. In an example use mode, the user can play back the words or sounds or other audio output by substantially replicating the gesture corresponding to the words as stored in the maps.

Words 720 are shown by way of example in the upper left of each diagram is the word that has been mapped (i.e., is associated with that particular active map). In an example, the words 720 are also the map name, although different names may be given to the maps. The active maps 710 are a snapshot of what may be shown to the user in the feedback window. The circled locations 730 within the active map 710 are where the user's gestures need to be in order to generate the desired output. By way of illustration, the areas 740 shown to the right of the active map 710 indicate for the user which wrist roll has been assigned to that active map, and that the user needs to achieve, along with the direction in which the user should move through the location (i.e., as detected by one or more of the bands) to activate audio output of the corresponding word 720 (or other audible sound). Words can be combined to generate sentences 750.

During operation, an input-detection algorithm determines the defined ranges for each orientation and flex sensor from within a cluster and then classifies the remaining coordinates as noX-input. As real-time input is received by the system, the algorithm compares the real-time input to the coordinate ranges of each input within the associated cluster. When real-time input meets all input requirements within a mapping, the associated output is immediately triggered.

The device also enables the user the ability to move around their environment without resetting their “forward” position. Doing so would be cumbersome and does not make for ease of use nor fluid conversation. When the shoulder band is included as a device component, users can freely move, and their positioning (or locations) automatically move with them. This can be achieved by the user wearing at least one wristband and one shoulder band.

The device also enables the ability to detect depth via elbow bend and/or wrist position. The bend of the elbow determines how close the hand is to the body, which is referred to herein as “depth,” and is achieved by wearing hardware inside an elbow band.

The device also includes a “No Input” algorithm. Machine learning algorithms used for gesture detection may not recognize “nothing.” For example, internet searches utilize machine learning algorithms and will always return results even if you request garble. Meaning, if you type the following into your search engine, you will receive results “laksdjdfaghaf lalskdjf; a.” Applying this example to a gesture-control device means the machine learning algorithms determine the closest input, even if the user is not within any defined input ranges, which produces unwanted results. The input algorithms disclosed herein are not necessarily required to utilize machine learning (although in other embodiments, machine learning may be implemented), and thus, the device recognizes when the user is NOT within predefined inputs. It is like the white space in a painting. Some say the white space (no input) is as important as the painted image (defined inputs). Without this feature, it is hard to keep the device “quiet,” so to speak, because every time you move your wrist or fingers, the algorithm is constantly attaching that movement to the nearest possible input, which produces unintended outputs. This problem is eliminated with the algorithms disclosed herein.

In an example, users can view how the program is registering with the feedback panel. This feedback panel may be displayed on a computer monitor, the feedback viewer worn by the users, or handheld or other user device (e.g., the user's mobile phone or tablet or smartwatch or smart glasses, etc.). Regardless of technical cognizance, users can easily comprehend that the movement of their arm(s) moves the indicator(s) on the screen. Visual feedback on the screen coupled with haptic and/or LED light feedback from the wristband(s) helps prepare users for when they are independent of a computer. Some users though will always need or want feedback and may don the feedback viewer when away from the computer, which projects the same feedback panel as seen on the screen and described herein.

In an example, the feedback panel includes animations which move in relation to the associated real-time sensor input. Location inputs used in the current cluster's mappings are identified by highlighting the inputs' orientation ranges. Hand shapes, wrist rotations, palm tilts, and buttons used in the current cluster's mappings are listed in a subpanel. When real-time input meets input criteria, the associated parts of the animation light up alerting users as to which inputs have been met. When an entire input mapping criteria has been met, the input name is displayed (along with the output being produced). If the mapping is sequenced, the system displays alerts when each sequence is met. Another alert is displayed when the output is triggered. If short descriptions and/or images are included in the setup panels, they are also displayed in the Feedback Panel when criteria are met.

In an example, predefined inputs and maps may be imported. Once imported they are added to the users inputs and maps collections, after which they may be used exactly as they were imported or modified. The process tracks the history of each preset imported to remove import redundancy.

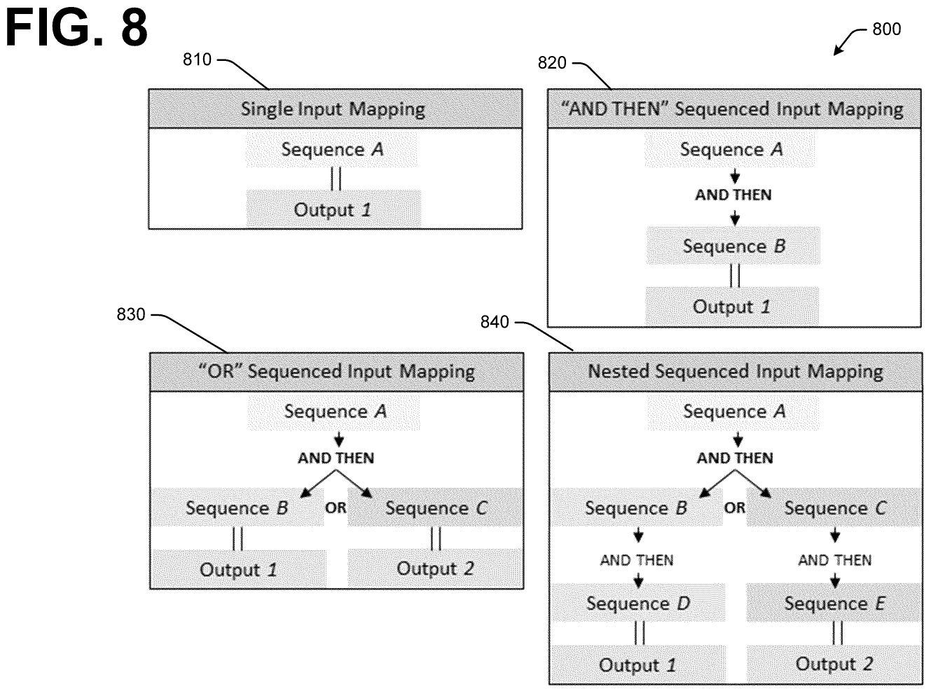

FIG. 8 is a high-level block diagram of example mapping inputs 800 of the sign to speech device. In FIG. 8, a single input mapping 810 is shown wherein Sequence A (corresponding to a user gesture) corresponds to Output 1 (a word or other audio/sound). An AND THEN sequenced input mapping 820 is illustrated to show Sequence A AND THEN (“followed by”) Sequence B results in Output 1. Output 1 is not triggered unless both Sequence A and Sequence B are true. An OR sequenced input mapping 830 is illustrated to show Sequence A which may then be followed by Sequence B (which results in Output 1) OR may be followed by Sequence C (which instead results in Output 2). A next sequenced input mapping 840 is illustrated to show Sequence A which may then be followed by Sequence B AND THEN Sequence D (which results in Output 1), OR Sequence A may be followed by Sequence C AND THEN Sequence E (which instead results in Output 2).

It is noted that the examples shown in FIG. 8 are merely illustrative and not intended to be limiting. Other sequence mapping scenarios are also contemplated as being within the scope of this disclosure, as will be readily apparent to those having ordinary skill in the art after becoming familiar with the disclosure here.

During use, if the “Sequence Inputs” option is checked in the cluster setup panel and the real-time input meets all inputs within a base mapping, the algorithm temporarily stops the trigger from producing the associated output and detects the immediate next real-time movement of the arm(s). Using this information, the algorithm predicts if the user is continuing with a sequence or not by analyzing the possible next moves of the sequence and comparing the possibilities to the real-time inputs. If the real-time input is not following the route of a possible next move, the trigger is then released, and the base output is immediately produced. If the real-time input is following the route of a possible next move, then the trigger continues to be held until the real-time input either meets sequence criteria, at which point the above process is repeated, or until the real-time input verges off all sequenced routes and releases the trigger.

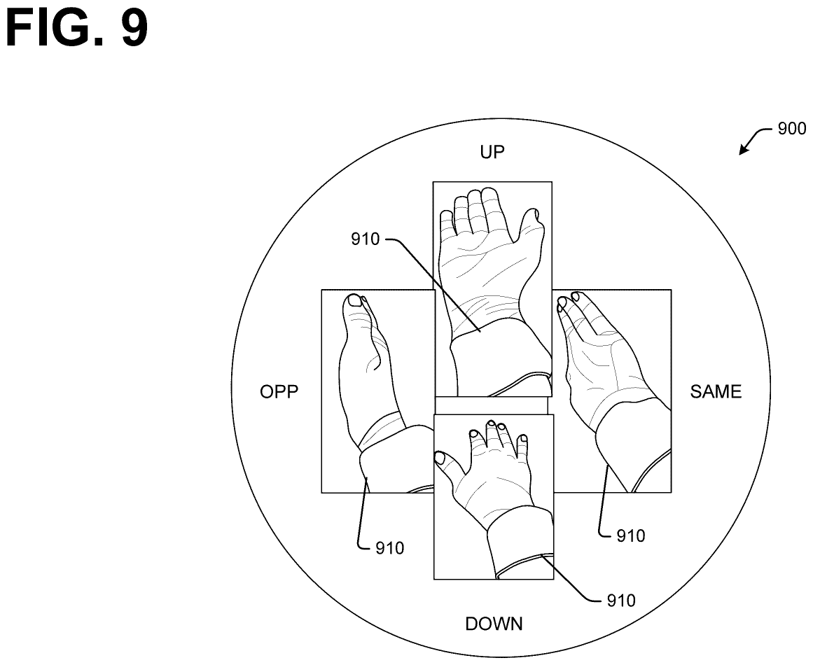

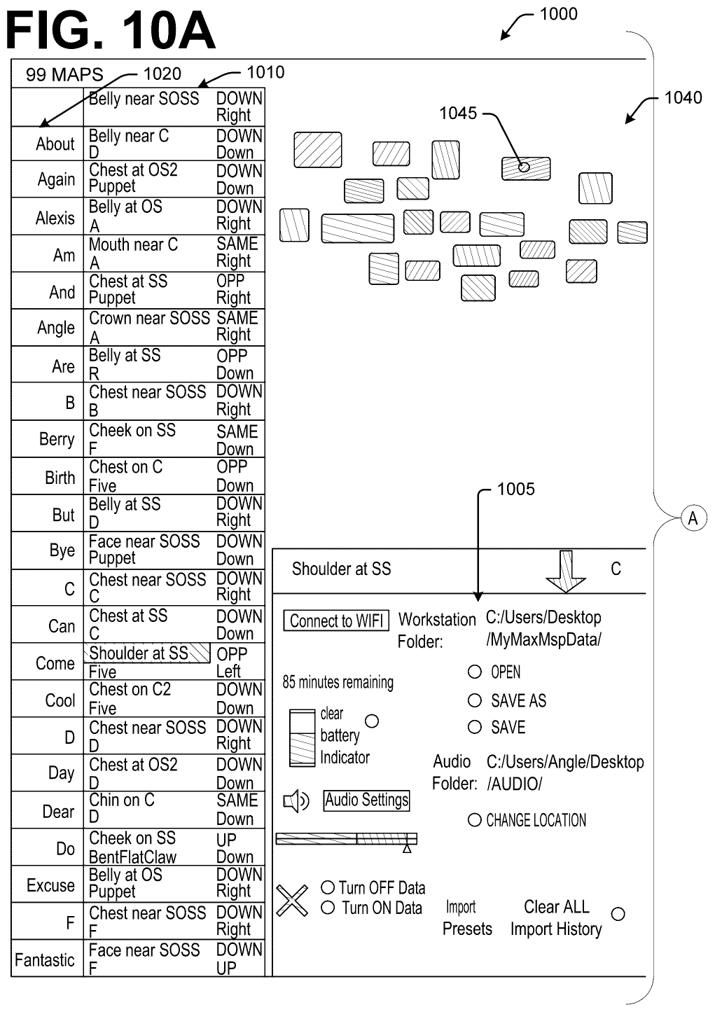

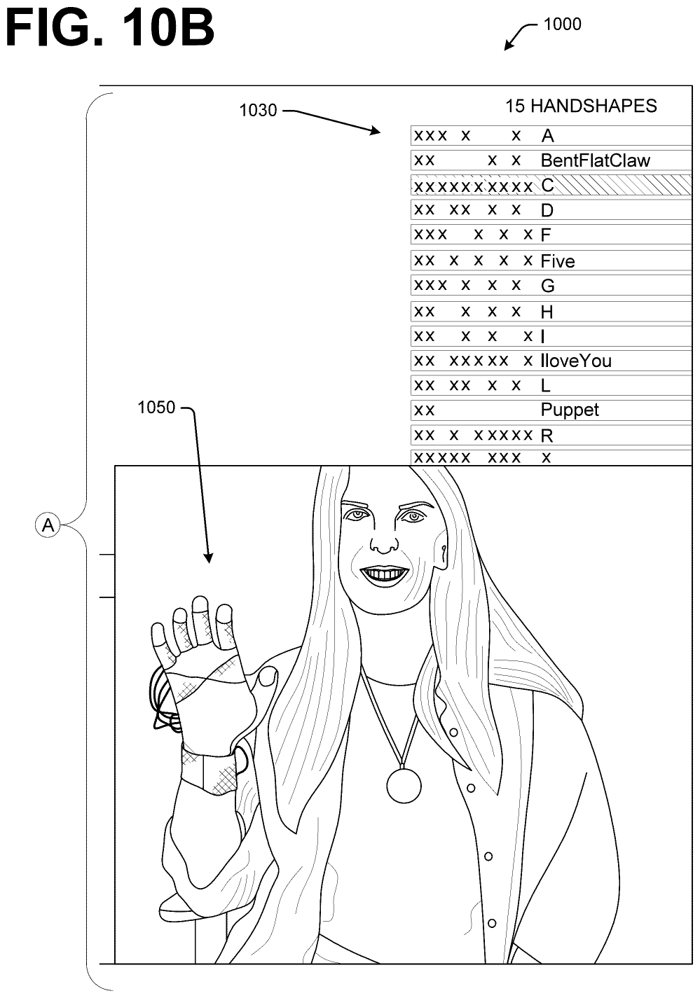

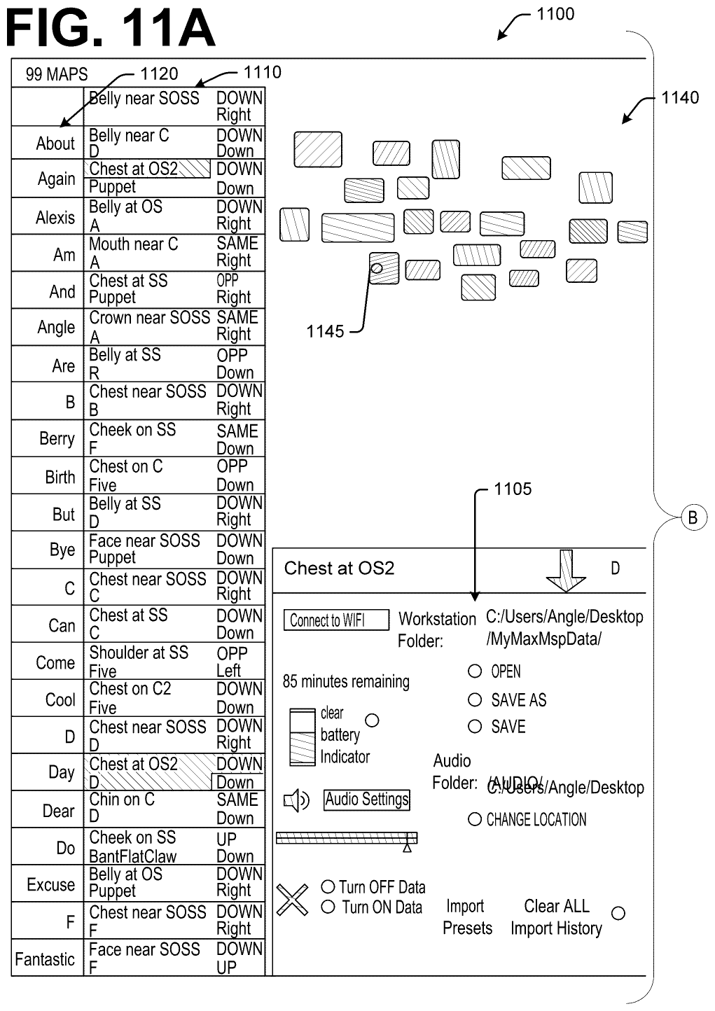

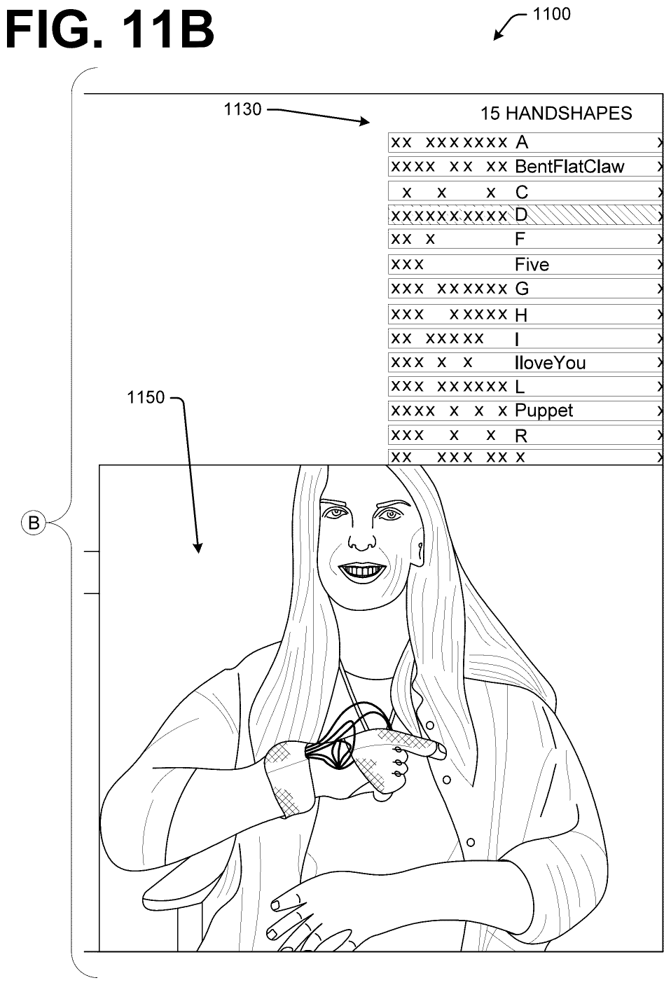

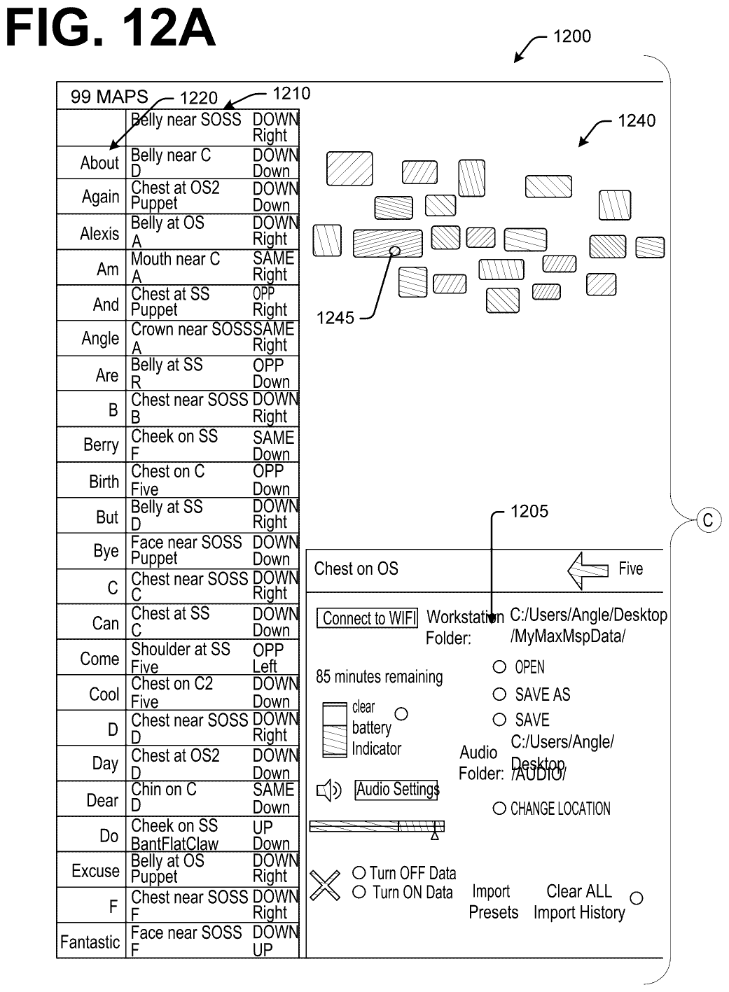

FIG. 9 illustrates example operation 900 of a wristband 910 of the sign to speech device. In FIG. 9, the user may wear the wristband 910 and perform different gestures (e.g., up, down, opposite, and same). These gestures may be detected by the sensor(s) in the wristband 910 and analyzed by the program code discussed herein to map and then generate audio output for the user. Example use cases are illustrated in FIGS. 10A-B, 11A-B, and 12A-B discussed in more detail below.

It is noted that the wristband 910 is shown merely as an example of one type of band that may be implemented. It will be readily understood by those having ordinary skill in the art after becoming familiar with the teachings herein how gestures may be formed and detected by the wristband 910 and the other bands.

FIGS. 10A-B, 11A-B, and 12A-B illustrate an example user interface and corresponding processing by a computing device of the sign to speech device. FIGS. 10A-B show a user interface 1000 with various settings 1005. FIGS. 11A-B show a user interface 1100 with various settings 1105. FIGS. 12A-B show a user interface 1200 with various settings 1205. Each of these user interfaces 1000, 1100, and 1200 correspond to different handshapes or gestures that a user is making in the insets 1050, 1150, and 1250.

In FIGS. 10A-B, user gesture positions 1010 are shown in the left portion of the user interface 1000 as these may be mapped to words 1020. Example handshapes (or gestures) 1030 are shown in the right portion of the user interface 1000 in FIG. 10B. The corresponding definition blocks 1040 are shown in FIG. 10A. An inset 1050 of the user is shown in FIG. 10B. The gesture made by the user shown in inset 1050 corresponds to the definition block 1045 seen in FIG. 10A.

In FIGS. 11A-B, user gesture positions 1110 are shown in the left portion of the user interface 1100 as these may be mapped to words 1120. Example handshapes (or gestures) 1130 are shown in the right portion of the user interface 1100 in FIG. 11B. The corresponding definition blocks 1140 are shown in FIG. 11A. An inset 1150 of the user is shown in FIG. 11B. The gesture made by the user shown in inset 1150 corresponds to the definition block 1145 seen in FIG. 11A.

In FIGS. 10A-B, user gesture positions 1210 are shown in the left portion of the user interface 1200 as these may be mapped to words 1220. Example handshapes (or gestures) 1230 are shown in the right portion of the user interface 1200 in FIG. 12B. The corresponding definition blocks 1240 are shown in FIG. 12A. An inset 1250 of the user is shown in FIG. 12B. The gesture made by the user shown in inset 1250 corresponds to the definition block 1245 seen in FIG. 12A.

In an example, being able to view real-time feedback of which inputs are being activated can help with user success. When users are connected to a computer, they view their feedback on the screen (e.g., as real-time visual feedback). When the device is being used independently of a computer, the feedback viewer, smart glasses, is activated by connecting wirelessly to the primary wristband, which in turn projects the feedback to the user's eyes.

The sign to speech device may be executed by software or program code. In an example, the graphical user interface (GUI) is designed in a user-friendly and system-guided way, so that it is easily navigated. The system may include various components including, yet not limited to setup panels, training games, feedback panels, instructional materials, inputs, maps, and output terminals. The program code may be set up on a computer, yet, at any time, the user may write the program code and/or corresponding definition(s) to their primary PCB. Upon completion, the user is able to unplug the USB and move away from their computer while still producing outputs and without the need for an external app and Wi-Fi. Executing the program code directly on a computer enables users the added option of sending MIDI and/or OSC messages to external programs.

When using the device independently of a computer, the device's primary PCB receives the real-time input, normalizes it, compares it to pre-defined input mappings, and then produces the associated pre-defined output. Both PCBs receive the associated flex sensor and button signals though wired connections. The secondary PCB sends its flex sensor and button signals to the primary PCB through a wireless connection. The hand-held button board issues signals directly to the primary PCB.

During operation, the program code continuously analyzes real-time user input against defined input regions and when criteria from all defined inputs in a particular mapping are met, an associated output is triggered.

When executing the program code on a computer, real-time input is collected by the primary PCB, as described above. However instead of analyzing the signals directly on the chip, the signals are sent to the program code installed and running on a connected computer. Additional functionality is available when executing the program code on a computer, such as setup panels, input and output mappings, instructional materials, and a training program. When written back to the primary PCB for independent use, the program code and/or definitions may include input mapping, real-time analyzation algorithms, feedback, and output processes.

In an example, activating devices involves setting up a Com Kit and occurs in the global setup panel. First, the PCB(s) and IMU(s) are turned on. Then, the system scans for connections. Once established, a series of confirmations takes place to ensure the system has assigned each device to the correct band. When detected devices are confirmed, the devices are activated and the system is able to receive real-time input. All other parts of the system (e.g., setup panels, maps, instructional material, and the training program) refer to the identified Com Kit to provide tailored material specific to the bands donned.

After the appropriate devices are activated, the system guides users through a series of steps to calibrate each device. Then users may define defaults for the speech voice (such as pitch and velocity), and sending MIDI and OSC messages (e.g., IP address, port, channel, message type, etc.). There may also be an option to write program code and/or definitions to the primary PCB for use independent of a computer.

A cluster is a unique set of maps to be executed without interference from other maps. For example, one cluster may include maps with location inputs triggering speech outputs, while another cluster may include maps with the same locations, yet triggering music outputs. Within each map, the system allows users to associate a short description and/or an image, which can be displayed on the Feedback panel discussed below.

Handshape coordinates track the bend of the fingers, comes from the flex sensors, and are used to define specific signal ranges for each sensor, which when combined with all active sensors on one hand, creates handshape inputs to be used in mappings. The Handshape Setup panel offers users the option of creating a new handshape or selecting from a list of previously declared handshapes. If there are not any finger bands activated in the Com Kit, the handshape setup panel is not available to the user.

When creating a new handshape, the system directs the user to enter a unique name for the handshape. Next a message is displayed directing the user to place their fingers in the desired handshape and then press a button on their button board or a key on the computer keyboard. The algorithm retrieves coordinates defining the bend of the user's fingers, then displays a message when the algorithm is finished gathering coordinates. The algorithm then creates a numeric range for each activated finger sensor and compares the combined ranges to other declared handshapes. If the newly created handshape range crosses over into another handshape's range within the same cluster, meaning both handshapes can be triggered simultaneously, the system alerts the user to either remove one of the handshapes or adjust one of the ranges. If the newly created handshape range crosses into another handshape's range from a different cluster, the user is given the option of keeping both hand shapes as they are, or using the pre-existing handshape.

When the newly created handshape is defined, the system declares the handshape as an input to be used in mappings and displays the handshape name and real-time feedback in a preview panel.

In addition to recognizing when real-time flex sensor input is within handshape input ranges, the algorithms also recognize when the input is not meeting any handshape range, allowing the user a neutral handshape, or white space. The algorithm includes the following in its formula: If real-time coordinates are not handshapeA and not handshapeB and not handshapeC and not handshape . . . , then handshape=noHandshape. This neutral handshape allows users to easily move out of declared handshapes, so as to avoid triggering unwanted outputs, and is also offered as a mapping input. For example, a user may select to display a particular color combination on their LED lights when their finger coordinates register noHandshape. The Feedback panel displays indicators when real-time coordinates meet handshape input, including this neutral position.

In an example, location coordinates track the orientation of the wrist, comes from the wrist IMUs, and defines regions of space to be used as location inputs within cluster mappings. The location setup panel offers users the option of creating a new location or adjusting a previously declared location.

When creating a new location, the system directs the user to enter a unique name for the location. A preview location is displayed in the Feedback panel and the user is directed to adjust the location to the specific area and size of their choice.

When the newly created location is defined, the system adds the location as a declared input to be used in mappings. After the input is declared, the system displays the location name, real-time input, and the defined orientation ranges in a preview panel and in the feedback window. After which, users may declare a new location or modify one previously defined.

Declared locations are displayed in the locations panel as a list with the location name and an activation checkbox. The locations are also displayed in the feedback window.

When the shoulder band is activated, the wrist IMU's forward yaw orientation is continuously updated to accommodate adjustments from the shoulder IMU. The algorithm does this based on the forward yaw coordinate points from the all activated IMUs. As the shoulder IMU's yaw orientation changes (when the user moves their torso), the algorithm continuously tracks the difference of the actual yaw and the forward yaw. This difference is continuously added to the additional IMUs' forward yaw. In this manner all locations remain relative to the torso, regardless of user movement. If the shoulder band is not activated, then this algorithm is bypassed, and the user resets their forward position every time they move.

In addition to recognizing when real-time orientation coordinates are within location input ranges, the algorithms also recognize when the coordinates are not meeting any location range, allowing users a neutral location. The algorithm includes the following in its formula: If real-time coordinates are not locationA and not locationB and not locationC and not locationD, then the location equals a noLocation. This neutral location is offered as a mapping input. For example, a user may select to produce a particular vibrational pattern on their haptic motor when their real-time orientation coordinates registers noLocation.

In an example, wrist rotation coordinates track the roll of the wrist. This comes from the wrist IMU's roll orientation coordinates, and is used to define angular rotations of the wrist to be used as inputs in mappings. The palm rotations setup panel offers users the option of creating a new set of wrist rotations. When a new set of wrist rotations is chosen, the system guides the user to set their palm prone position, their palm supine position, and the number of segments desired. The algorithm uses this information to automatically set the wrist rotations, and each segment becomes an input to be used when mapping. The system displays the segmented wrist rotation names, real-time input, and the declared segmented ranges in the feedback window.

In an example, palm tilt coordinates track the flexion of the palm, comes from the flex sensor located on the top of the wrist, and is used as inputs in mappings. If there are not any palm tilt flex sensors activated in the Com Kit, the Palm Tilt Setup panel is not available to the user.

When setting palm tilts, the system guides the user in setting the extension of the palm as far up and down as possible. Then the user is prompted to select the desired number of palm tilts and corresponding names, which the algorithm uses to break the palm tilt range into segments and adds them as inputs for mapping. The system displays the segmented palm tilt names, real-time input, and the declared segmented ranges in the feedback window.

In an example, affixes are declared in this panel and are then displayed with other declared affixes as a list. These also become available as inputs when sequencing maps.

In an example, each wristband includes a built-in button and is automatically available as an input for mapping. The hand-held button board includes a number of buttons which are available as either inputs or menu control. The button board may include a setup panel to declare how each button will be used. The primary wristband button is automatically available for all users, and the secondary wristband button along with the button board become available when they are activated within the Com Kit.

In an example, users have the option of declaring a sound, instrument, or song for the music terminal to default to when mapping. The default can be changed in each map. The system also provides users the ability to set MIDI or OSC as the default option mapping. When OSC is chosen, users have the option of setting a default IP address and port. When MIDI is chosen, users have the option of setting the default message type and channel. The defaults can be changed in each map.

In an example, maps define particular sets of inputs along with associated outputs. The Mapping Setup panel allows users to create new maps or modify existing ones. Options are provided to define which inputs are to be used in each map. Options provided vary depending on the Com Kit and declared inputs. Users then select the output terminal(s) they desire, which will present with options to further define their outputs. Additionally, users may select to add sequences to the map.

In an example, a window displays all declared inputs where users activate input terminals of their choice. For example, one map might include only the location and wrist roll terminal, where another map may include the location, handshape, wrist roll, movement, and palm tilt terminals. Once terminals are chosen, individual inputs from the activated terminals are identified.

After inputs are identified, the system provides the option of sequencing the mapping. When chosen, the user is guided to identify the direction toward the next sequence, and then the next location, hand shape, palm tilt, and wrist rotation. When defined, the system provides an option for adding another sequence. If users select to add more than one sequence, the system provides a prompt asking if the sequence follows “and then” logic or “or” logic. The “and then” logic sequences the mapping after the previous sequence. Using a speech example, this logic could produce a sequence such as, “Thank” (base map)+“Full” (first sequence)+“Ly” (second sequence), which in turn provides the user the opportunity to have three outputs built into one map. In this case, the outputs would be “Thank,” “Thankful,” and “Thankfully” depending on how the user moves through the sequence. The “or” logic provides an additional sequence option connected to an existing sequence. For example, another sequence could be added along with the second sequence, described above, enabling the user to produce either “Thankfully” or “Thankfulness”.

In an example, output terminals providing users with speech, music, hardware control, and streaming options are chosen from the output mapping section of the Maps Setup panel. Each terminal is described below. Any terminal can be used in conjunction with any other output terminal within the same map, while some terminals, such as the Control terminal, may be used multiple times within one map. Additionally, every terminal provides the option of manually triggering the output.

In an example, an LED light, haptic motor, cluster switching, and volume control options are provided in the Control terminal. When this terminal is chosen, users are presented with the aforementioned output options. Selecting LED lights provides users with fields to customize each of the LED lights on the wristband, such as color, blink speed, and on/off patterns. Selecting the haptic option presents users with fields for customizing the pattern, speed, and strength of the vibrational feedback from the haptic motor also located on the wristband. Selecting cluster switching allows users to identify an existing cluster to switch to, and the volume control option allows users to turn the sound up and down or mute it. After users define the control, the system provides the option of adding another control output. For example, users may select to have an input mapping trigger a light pattern and haptic feedback simultaneously.

In an example, selecting the speech terminal provides fields defining words or phrases, and the voice defined in the global setup panel is automatically applied.

In an example, the music terminal provides fields for users to define musical sounds to be played when triggered. The system defaults to the sound, instrument, or song identified in the music terminal setup panel, yet can be changed in the output mapping when desired. If no default is defined, the system directs users to select a sound, instrument, or song. When a sound is chosen, users are given customization choices such as adjusting the pitch and length of the sound. When an instrument is chosen, a piano keyboard is displayed for the user to click on a note or combination of notes, along with the ability to define note length. When a song is chosen, a track of the song is presented, and the user is directed to select a clip from the song to be played when the output is triggered. The song may also be played in its entirety if the user desires.

In an example, dragging the streaming terminal into the output mapping section provides users with default fields defined in the streaming terminal setup panel, which can be changed if the user desires. If there is not a default defined, the system directs users to select between streaming a MIDI or OSC message. When MIDI is chosen, users enter channels, controller numbers, and integer, or note, values. When OSC is chosen, users enter the IP address, port, and message.

In an example, instructions are “built-in” to the device, which are automatically customized according to the identified Com Kit. Instructions include how to navigate and use the system and the devices. Additionally, a sign system sign dictionary is included. The manual can be accessed through the menu bar or by clicking associated quick links placed throughout the program.

In addition to step-by-step instructions, the device may also include a training program to help users learn how to use the device and improve their skills. Using sophisticated algorithms, the training program caters specifically to each user by adjusting in real-time to accommodate their continuously changing abilities. Training is presented as games with speech, music, and visual feedback, and can be performed on a computer or routed to the feedback viewer.

In an example, users view real-time feedback which displays animations of actual gestures, motions, and met criteria. For example, when the user moves their hand into location x, the animation also moves into location x and location x lights-up in a particular color. Feedback can be viewed on a computer screen or the feedback viewer. With the device feedback, users easily navigate to the proper inputs, view input series, and see what they are saying in real-time. With feedback, unintended outputs are minimized, yet if a user does trigger the wrong word or statement, they simply sign it again, just like if orally speaking people accidentally say the wrong word.

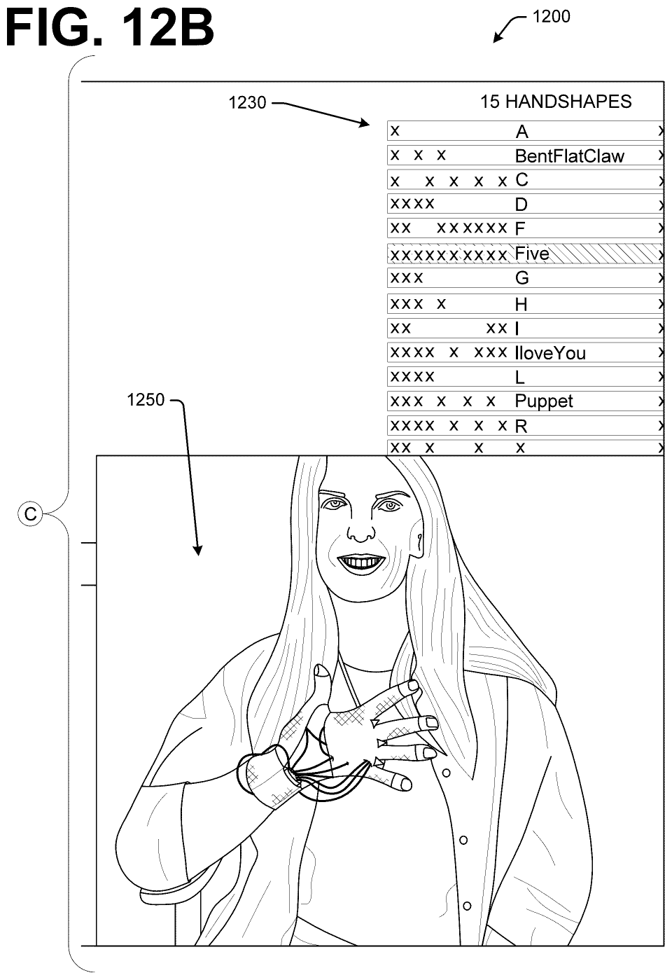

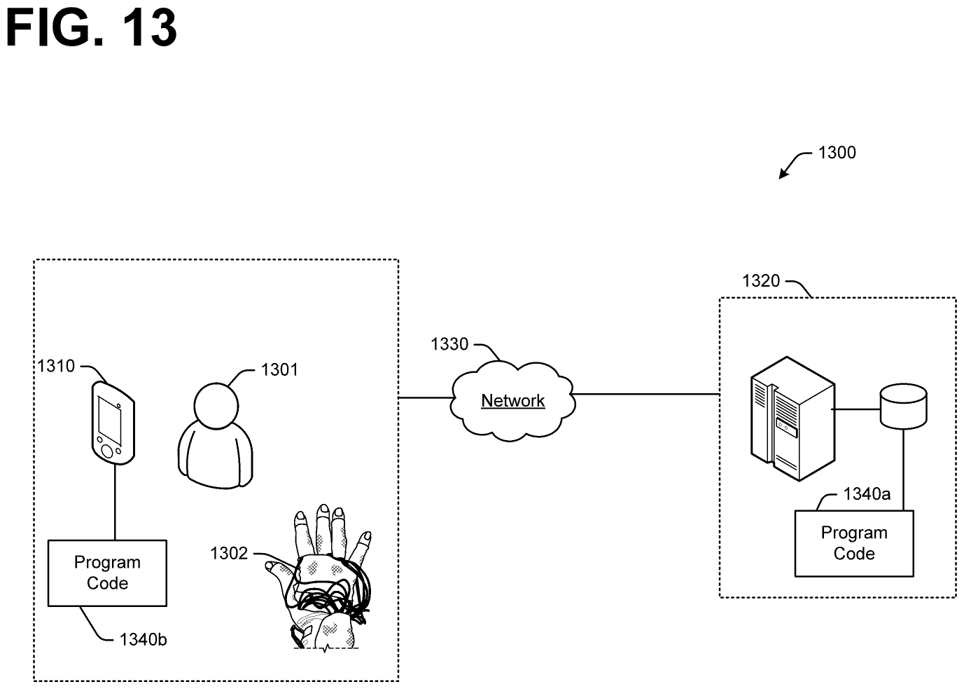

FIG. 13 is a high-level block diagram of an example computing environment or system 1300 in which the sign to speech device 1310 may be implemented. System 1300 may be implemented with any of a wide variety of sensors 1302 and associated computing devices, such as, but not limited to, stand-alone desktop/laptop/netbook computers, workstations, server computers, blade servers, mobile devices, and appliances (e.g., dedicated computing devices), to name only a few examples. Each of the computing devices may include memory, storage, and a degree of processing capability at least sufficient to manage a communications connection either directly with one another or indirectly (e.g., via a network). At least one of the computing devices is also configured with sufficient processing capability to execute the program code described herein.

In an example, the system 1300 may include the sign to speech device 1310 and a setup device 1320. The sign to speech device 1310 may be associated with the user 1301. For example, the sign to speech device 1310 may be worn or carried by the user as a dedicated device (e.g., the bands and/or as a mobile device). The setup device 1320 may execute a processing service (e.g., configured as a computer with computer-readable storage 1312). Example processing may include general purpose computing, interfaces to application programming interfaces (APIs) and related support infrastructure.

The system 1300 may also include a communication network 1330, such as a local area network (LAN) and/or wide area network (WAN). In one example, the network 1330 includes the Internet or other mobile communications network (e.g., a 4G or 5G or other network). Network 1330 provides greater accessibility for use in distributed environments, and as such, the sign to speech device 1310 and setup device 1320 may be provided on the network 1330 via a communication connection, such as via a wireless (e.g., WiFi) connection or via an Internet service provider (ISP). In this regard, the sign to speech device 1310 is able to access setup device 1320 directly via the network 1330, or via an agent, such as another network.

Before continuing, it is noted that the computing devices are not limited in function. The computing devices may also provide other services in the system 1300. For example, the setup device 1320 may also provide transaction processing services not specifically set forth herein. The operations described herein may be executed by program code 1340a, 1340b. In an example, the program code 1340a may be executed during setup at the setup device 1320 and the program code 1340b may be executed on the handheld portion of the sign to speech device 1310. However, the handheld portion of the sign to speech device 1310 and the setup device 1320 are not limited to any particular type of devices (and may indeed be the same physical device), configuration, and/or storage and execution location of the program code 1340a, 1340b.

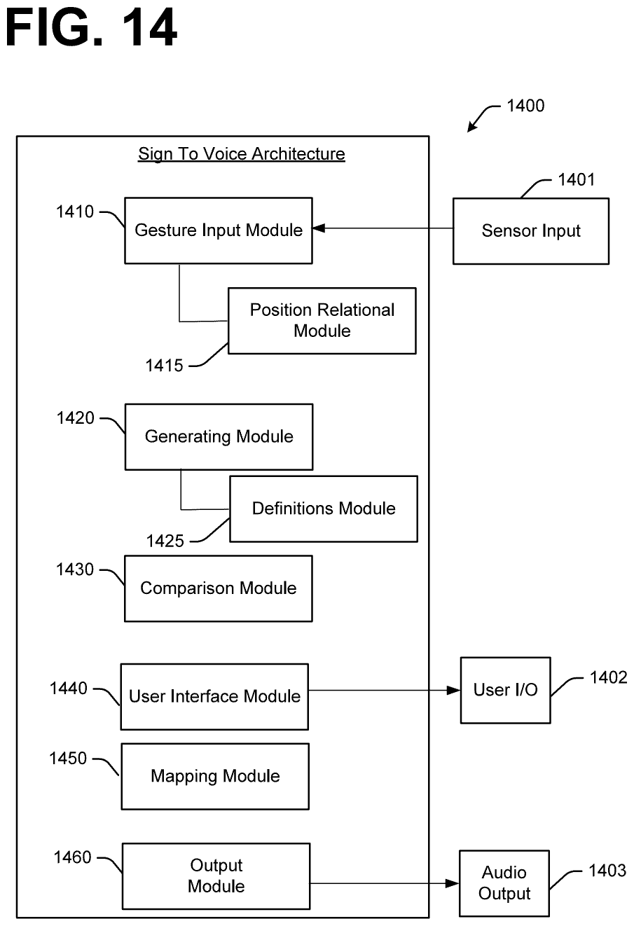

Program code used to implement features of the system can be better understood with reference to FIG. 14 and the following discussion of various example functions. However, the operations described herein are not limited to any specific implementation with any particular type of program code.

FIG. 14 shows an example architecture 1400 of machine readable instructions, which may be executed for the sign to voice device. In an example, the program code discussed above with reference to FIG. 13 may be implemented in machine-readable instructions (such as but not limited to, software, firmware, or other program code). The machine-readable instructions may be stored on a non-transient computer readable medium and are executable by one or more processors to perform the operations described herein. It is noted, however, that the components shown in FIG. 14 are provided only for purposes of illustration of an example operating environment, and are not intended to limit implementation to any particular system.

The program code executes the function of the architecture of machine readable instructions as self-contained modules. These modules can be integrated within a self-standing tool, or may be implemented as agents that run on top of an existing program code.

In an example, the architecture 1400 of machine readable instructions may include a gesture input module 1410. The gesture input module 1410 receives sensor input 1401 for the new physical gesture based on the electrical signals from the motion detection device(s). The gesture input module 1410 may also be operative with a position relational module 1415. The position relational module 1415 processes relational coordinates (e.g., based on sensor input from activated IMUs such as from a shoulder and/or wrist band.

The architecture 1400 may also include a generating module 1420. The generating module 1420 generates a new physical gesture definition based on the received input. The generating module 1420 may also generate a numeric range for each active motion detection sensor associated with the new physical gesture definition based on the received input. The generating module may also be associated with a definitions module 1425. In association with a comparison module 1430, the numeric range of the new physical gesture definition may be compared to previously declared physical gesture definitions.

For example, the user interface module 1440 may alert the user to remove one of the new physical gesture definitions or one of the previously declared physical gesture definitions if the numeric range of the new physical gesture definition crosses the numeric range of any of the previously declared physical gesture definitions within the same cluster.

In another example, the user interface module 1440 may provide the user with an option to discard one of the new physical gesture definition, or one of the previously declared physical gesture definitions, or keep both if the numeric range of the new physical gesture definition crosses the numeric range of any of the previously declared physical gesture definitions within a different cluster.

The architecture 1400 may also include a mapping module 1450. The mapping module 1450 may map the audible sound 1403 to the new physical gesture definition. The audible sound 1403 may be rendered by an output module 1460 (e.g., via a speaker or other audio output). The mapping module 1450 may also declare the new physical gesture definition as an input for mapping. In an example, the output may be generated in a preview panel or other display for the user.

Before continuing, it should be noted that the examples described above are provided for purposes of illustration, and are not intended to be limiting. Other devices and/or device configurations may be utilized to carry out the operations described herein.

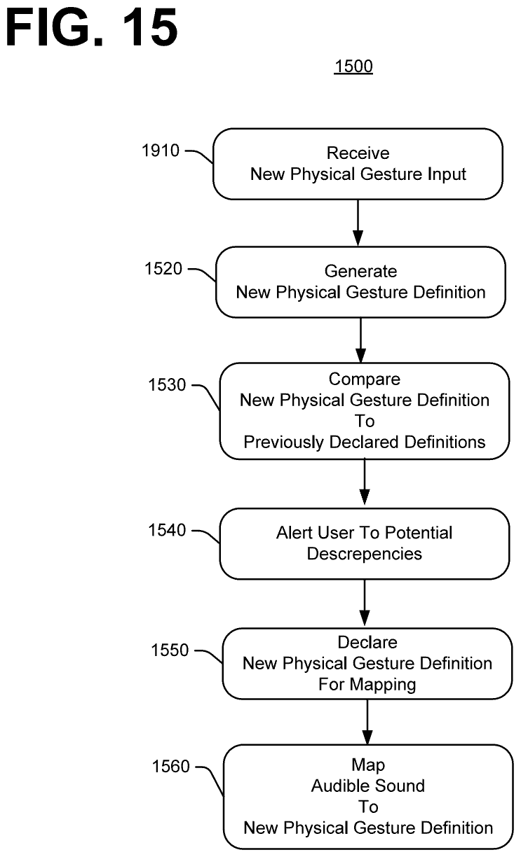

FIG. 15 is a flowchart illustrating example operations which may be implemented for the sign to speech device to define a new physical gesture. Operations 1500 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

It is noted that the operations shown and described herein may be implemented at least in part using an end-user interface (e.g., a computer, mobile device, dedicated device or appliance, and/or web-based interface). In an example, the end-user is able to make predetermined selections, and the operations described above are implemented by a computer processor to present results to a user. The user can then make further selections. It is also noted that various of the operations described herein may be automated or partially automated and/or performed by more than one user.

Operation 1510 includes receiving input for the new physical gesture based on the electrical signals. Operation 1520 includes generating a definition of the new physical gesture. Operation 1530 includes generating a numeric range for each active motion detection sensor associated with the new physical gesture based on the definition. Operation 1540 includes comparing the numeric range to previously declared physical gestures. Operation 1550 includes alerting the user to remove one of the new physical gestures or one of the previously declared physical gestures if the numeric range of the new physical gesture crosses the numeric range of any of the previously declared new physical gestures within the same cluster. Operation 1560 includes providing an option for the user to discard one of the new physical gestures or one of the previously declared physical gestures, or to keep both if the numeric range of the new physical gesture crosses the numeric range of any of the previously declared physical gestures within a different cluster. Operation 1570 includes declaring in a preview panel for the user the new physical gesture as an input for mapping. Operation 1580 includes mapping the audible sound to the declared physical gesture.

The operations shown and described herein are provided to illustrate example implementations. It is noted that the operations are not limited to the ordering shown. Still other operations may also be implemented.

Still further operations are contemplated as described herein and as will become readily apparent to those having ordinary skill in the art after becoming familiar with the teachings herein.

Careful consideration has been given to the design to ensure best fit, comfort, and ease of use for the nonverbal—a demographic hosting a wide range of abilities and physiognomies. The nonverbal are ambulatory, they are wheelchair bound, some user walker or canes, they may present with non-standard sizes, some do not have control over an arm, others can only control one finger, while yet others may possess exceptional dexterity with all of their fingers. People who are nonverbal often have cognitive impairments and developmental delays, some never exceeding the cognitive level of an infant on standardized testing. Many will be hard on their devices. The sign to speech device accommodates all of these special, nonverbal realities and more.

Even though the sign to speech device is not specifically for the Deaf, the device is still easily used by people who cannot hear.

Although the sign to speech device gives people who are hearing-nonverbal a voice, performing artists also enjoy the device because of the ability to stream to any system accepting MIDI or OSC messages, the ease of use and customization of mappings, the built-in training, and the ability to move around on stage while automatically keeping their locations relative to their body. The device's versatility makes it a valuable addition for any performing artist whether singing, playing instruments, storytelling, dancing, or even manipulating visuals.

Hobbyists, people who code, use VR, play a WI, fly drones, or basically anyone who enjoys “tech gadgets” may also use the device because it provides abundant opportunity to explore gesture and motion control in fun and diverse ways.

The device easily fits on any adult's hands no matter how big or small. The system is easy for adults to use, and the training is challenging and engaging for mature minds.

In addition to adults, the device also fits well on children's hands no matter how big or small. The feedback is easy for young minds to understand, and the system stimulates their minds.

The device includes a sign system created for people who can hear, and which replicates spoken languages, including yet not limited to English, Spanish, Hindi, and French. The sign system builds signs/words morphemically, and in this manner with even just a few base signs and a few affixes, users have a large variety of signs/words at their fingertips. Additionally, the device produces speech outputs word-by-word, thus approaching natural communication, while allowing users to modify (through input mappings) how the speech is triggered.

The sign system disclosed herein differs from sign systems created for the Deaf. “Not hearing” is very different than “hearing,” and is something hearing people find challenging to fully grasp because, except for a possible medical complication, it is impossible for the Hearing to experience what it is like to be deaf.

A deaf child, being born into a deaf family and community, does not grow up thinking in words. If they were outside and looked up, they would not know they were looking at the “sky”, nor would they think of the collection of water particles as a “cloud.” Instead, they would sweep their hand in an arcing motion above their heads to describe the ambient air above, while clouds would be expressed by bouncing the hands, slightly curled and palms up, up and down a little while moving each hand towards its respected side—as though the hands are outlining the bottom of a fluffy cloud. When conveying “The cat has been under the table,” they would indicate what they are about to describe happened in the past, then they would sign “table” and visually place the “table” in front of their body with their non-dominant arm. Next, they would sign “cat,” then indicate the cat is now represented by their dominant hand, and lastly place their dominant hand under their non-dominant arm to show the cat under the table. It is in this visual manner that the Deaf communicate; not with words, but with gestural representations of objects, actions, concepts, thoughts, and feelings.

Because of such, words like “to,” “the,” “an,” “it,” “is,” “or,” “of,” “as,” etc. are not included in deaf sign systems. These sorts of words are tools used strictly in spoken languages to convey meaning. Another difference between spoken and deaf languages is the way synonyms are used. For example, in English one can convey feelings of pleasure by using the words “happy,” “joyful,” “delighted,” “merry,” “mirthful,” or “jolly” where each word embodies a different and meaningful variation of happy. Deaf sign systems do not include these synonyms per se. For example, there are no direct translations for the English variations of the word happy as discussed above. Instead, a deaf person will sign the gesture representing “in the state of happiness, and the more happiness they are attempting to express, the more they will put their body and facial expressions into the sign. They may even repeat the sign several times. When sign language interpreters translate such gestures, the spoken word they translate the sign (or set of signs) to is up to their discretion. In fact, multiple interpreters translating the same deaf person's statement, usually yield multiple translations (IE: one translator might say the person is happy, while another might express they were delighted).

Because deaf sign systems are not based on words, there are typically only between 4,000 to 6,000 direct translations of signs out of the 750,000 words available to speaking persons, as is with American Sign Language (ASL—the predominant sign system referred to in the USA). Other reasons there are so few signs compared to words is unknown. It baffles many hearing persons trying to learn sign language. In ASL specifically, there are no signs for the planets other than Earth, the only spices which have signs are salt and pepper, the words bleach, solution, bamboo, cupboard, bank, microscopic, festive, hyphen, stove, and pulchritudinous do not have signs, nor do the months of the year and most technical words.

Some more points to be made about deaf sign systems, specifically ASL, is two signs signed back-to-back can mean something entirely different than each individual sign. For example, “good” followed by “help” conveys helpful, “praise” followed by “celebrate” is signed for Hallelujah, daughter is signed “girl” plus “baby”, and son is “boy” plus “baby,” yet never is grasshopper “grass” plus “hopper,” nor is butterfly “butter” plus “fly,” as they are in the sign system. Deaf sign systems also do not use affixes. Therefore, using derivatives for the word “see” as an example, seeing is signed in ASL using the gesture for “now” followed by “see,” saw is signed with the gesture indicating “in the past” followed by “see,” oversee is signed with “see” followed by a gesture indicating “watching over a group or activities”, seer, seesaw, and sightsee are all signed gesturally different than see is signed, and sees, seen, seeable, farseeing, and foresee are not conveyed in the language.

The sign system accommodates the sign language needs of people who can hear yet not talk by allowing the nonverbal to speak the same language they are spoken to in, just like hearing-verbal people do. The key to this accomplishment is in the way signs are constructed following the same rules in which spoken words are created. In English this means morphemically. As such, the sign system includes base signs and affixes which can be combined to form different signs and follows a strict one-to-one rule, meaning each word is equivalent to one, and only one, sign. Continuing to use “see” as an example, in the sign system all of the signed variations have a sign and each includes the same gesture for “see,” thus, seeing is signed “see” plus the present tense ending, saw is the same sign except with the past tense ending added on, seen ends with the -en ending, oversee is “over” plus “see,” farseeing is the combination of “far” plus “see” plus the present tense ending, etc.

The structure of the sign system applies not only to English, it applies to all spoken languages. This does not mean the sign system can merely be translated from English to other languages. Instead, it means the sign system can be used in any language. This is an important differentiation. A simple example of using the sign system in various languages can be found with the words cat, kucing, billee, and ikati, all of which refer to the same carnivore of the family Felidae in English, Malay, Hindi, and Zulu respectively, and thus, all take on the same gesture in the sign system. In spoken Spanish, the carnivore is prefaced with the masculine or feminine articles “el” or “la” for el gato or la gata and would thus be signed with the sign representing el or la, followed by the sign for the animal. Making cat plural in the sign system English entails signing “cat” plus the plural ending. Making cat plural in the sign system Spanish involves signing the appropriate article plus the plural ending, followed by the sign for the animal. Another example uses the English word “please,” which translates to Spanish as “por favor.” When signing the sign system in English, the gesture for please is used. When signing the sign system Spanish, the gesture for “for” followed by the gesture for “favor” is used. These same patterns hold true across all grammatical rules within each language, and in this manner, the sign system is able to be a truly Universal sign system unifying communication across borders while highlighting and preserving the unique styles, cultures, and nuances of each spoken language.

Using the sign system with the device input detection algorithms allows nonverbal users a device which most approaches natural communication in the language of the users' choice. How do users learn how to sign the preset mappings included with the device? By taking advantage of the smart built-in instructional material and training program, which both automatically update themselves to match newly created and modified mappings and show users what they need to learn to become proficient communicators. In summary, the sign to speech device provides a much-needed voice to millions of people around the world.

It is noted that the examples shown and described are provided for purposes of illustration and are not intended to be limiting. Still other examples are also contemplated.

1. A sign to speech device comprising at least one motion detection sensor configured to detect physical motion of a user and generate electrical signals corresponding to the detected physical motion, a controller configured to receive the electrical signals from the at least one motion detection sensor and associate the electrical signals with a preprogrammed word, meaning, or sound, an audio output device configured to generate audible sound for the preprogrammed word, meaning, or sound based on the electrical signals corresponding to the detected physical motion, and program code stored on computer readable media and executable by a computer processor to define a new physical gesture of the user by:
receiving input for the new physical gesture based on the electrical signals;
generating a new physical gesture definition based on the received input;
generating a numeric range for each active motion detection sensor associated with the new physical gesture definition based on the received input;
comparing the numeric range of the new physical gesture definition to previously declared physical gesture definitions;
alerting the user to remove one of the new physical gesture definition or one of the previously declared physical gesture definitions if the numeric range of the new physical gesture definition crosses the numeric range of any of the previously declared physical gesture definitions within a same cluster;
providing an option for the user to discard one of the new physical gesture definition, or one of the previously declared physical gesture definitions, or keep both if the numeric range of the new physical gesture definition crosses the numeric range of any of the previously declared physical gesture definitions within a different cluster;
declaring in a preview panel for the user the new physical gesture definition as an input for mapping; and
mapping the audible sound to the new physical gesture definition.

2. The sign to speech device of claim 1, wherein the audible sound mapped to the new physical gesture is written to a wearable device.

3. The sign to speech device of claim 1, wherein the new physical gesture includes at least one handshape.

4. The sign to speech device of claim 1, wherein the new physical gesture includes positional coordinates for at least one handshape relative to other position relational input from the user.

5. The sign to speech device of claim 1, wherein the other position relational input from the user includes at least one of a position of the user's elbow.

6. The sign to speech device of claim 1, further comprising at least one customizable device component selected from at least one finger band, at least one wristband, at least one elbow band, and at least one shoulder band, wherein the at least one customizable device component is custom-fit to the user, and wherein the at least one customizable device component houses the at least one motion detection sensor.

7. The sign to speech device of claim 6, wherein in response to activating the shoulder band, the wristband forward yaw orientation is continuously updated to accommodate adjustments from the shoulder band by obtaining forward yaw coordinates from at least one of the wristband and the shoulder band, wherein as the shoulder band yaw orientation changes based on the user moving their torso, an algorithm continuously tracks a difference between actual yaw and forward yaw and continuously adds the difference to the forward yaw so that all locations remain relative to the user's torso regardless of the user's movement.

8. The sign to speech device of claim 6, wherein wrist rotation coordinates correspond to roll of the user's wrist and defines angular rotations of the user's wrist as inputs in mapping the new physical gesture of the user.

9. The sign to speech device of claim 6, wherein palm tilt coordinates correspond to flexion of the user's palm as inputs in the new physical gesture of the user.

10. The sign to speech device of claim 1, further comprising at least one wristband housing at least a first motion detection sensor, and at least one shoulder band housing at least one motion detection sensor, wherein relative positions of the at least one motion detector are calibrated against a position of the at least one wristband and a position of the at least shoulder band in order to detect relative motion of at least one other motion detection sensor so that the user can move about their environment to different locations and orientations without having to reset to a default position.

11. The sign to speech device of claim 10, further comprising at least one elbow band housing at least a position detection sensor, the at least one elbow band providing depth positions to the controller indicating how close the user's hand is to the user's body.

12. The sign to speech device of claim 1, further comprising a no input algorithm executable by the computer processor to reduce or eliminate audio output when input from the at least one motion sensor does not correspond to any of the previously declared physical gesture definitions.

13. The sign to speech device of claim 1, further comprising an input sequencing algorithm executable by the computer processor to sequence input from the at least one motion detection sensor before matching the new physical gesture definition with audio output.

14. The sign to speech device of claim 1, further comprising a feedback algorithm executable by the computer processor to generate a graphical representation corresponding to at least one position of the at least one motion detection sensor.

15. The sign to speech device of claim 14, further comprising a feedback device including a display for outputting the graphical representation of the feedback for the user.

16. The sign to speech device of claim 1, further comprising program code stored on the computer readable media and executable by the computer processor to recognize a user-defined neutral physical gesture by:
comparing received input from the at least one motion detection sensor with a plurality of the previously declared physical gestures; and
registering the received input as the user-defined neutral physical gesture when there is no match between the received input from the at least one motion detection sensor and the plurality of previously defined physical gestures.

17. The sign to speech device of claim 1, further comprising a location setup algorithm that tracks an orientation of the user's wrist and defining regions of space to be used as location inputs within cluster mappings.

18. The sign to speech device of claim 1, further comprising a new location definition algorithm that defines orientation ranges for the new location and adds the new location as a declared location for future mapping.

19. The sign to speech device of claim 1, wherein the program code stored on the computer readable media is further executable by the computer processor to sequence a plurality of the previously declared physical gestures based on user input identifying a direction toward a next sequence, and then a next set of input parameters.

20. The sign to speech device of claim 19, wherein the program code stored on the computer readable media is further executable by the computer processor to add another sequence by:
determining if the sequence follows “and then” logic or “or” logic, the “and then” logic sequences the mapping after the previous sequence; and
mapping multiple outputs into one audible sound.
